(19) United States
(12) Patent Application Publication
(10) Pub. No.: US 2024/0114905 A1
(43) Pub. Date: Apr. 11, 2024

(54) ANTIMICROBIAL COMPOSITIONS AND ARTICLES AND RELATED METHODS

(71) Applicant: 3M INNOVATIVE PROPERTIES COMPANY, St. Paul, MN (US)

(72) Inventors: Mahfuza B. Ali, Mendota Heights, MN (US); Jodi L. Connell, St. Paul, MN (US); Judith M. Invie, Woodbury, MN (US); Narina Y. Stepanova, Woodbury, MN (US); Bryan V. Hunt, Nowthen, MN (US); Timothy J. Hebrink, Scandia, MN (US)

(21) Appl. No.: 18/274,779

(22) PCT Filed: Jan. 28, 2022
(86) PCT No.: PCT/IB2022/050771

§ 371 Date: Jul. 28, 2023

Related U.S. Application Data
(60) Provisional application No. 63/152,666, filed on Feb. 23, 2021.
(60) Provisional application No. 63/142,553, filed on Jan. 28, 2021.

(51) Int. Cl. A01N 37/44; A01N 25/10; A01P 1/00

(52) U.S. Cl. CPC A01N 37/44; A01N 25/10; A01P 1/00

(57) ABSTRACT

The composition includes an antimicrobial monomer represented by formula CH₂═C(R¹)—C(O)—O-Q-N⁺(R)₂CₙH₂ₙ₊₁(X—), a non-fluorinated crosslinking monomer having at least two acrylate groups, methacrylate groups, or a combination thereof, a polar monomer having at least one of acrylic acid, methacrylic acid, or a carboxylate salt thereof, and a nonpolar monomer represented by formula CH₂═C(R¹)—C(O)—O—R². The antimicrobial monomer, the non-fluorinated crosslinking monomer, the polar monomer, and the nonpolar monomer together account for greater than 95 percent by weight, based on the total weight of the composition. The article includes a film having a plurality of pendent groups represented by formula —C(O)—O-Q-N⁺(R)₂CₙH₂ₙ₊₁(X—) covalently bonded in a crosslinked non-fluorinated acrylic network. A method of making an article is also described.

### CROSS-REFERENCE TO RELATED APPLICATION

This application claims priority to U.S. Provisional Application Nos. 63/142,553, filed Jan. 28, 2021, and 63/152,666, filed Feb. 23, 2021, the disclosures of which are incorporated by reference in their entirety herein.

### BACKGROUND

Contamination by microorganisms can have dramatic impact on human life and health. During everyday routines, people continuously come into contact with a variety of surfaces that are contaminated with one or more types of microorganisms, some of which may be pathogens. Such surfaces may include countertops, tables, and food preparation surfaces in restaurants, splash guards and conveyor belts in food processing plants, surfaces encountered in public facilities and while using public transportation, display applications, a variety of surfaces in healthcare settings, and many others. Contamination with pathogenic microorganisms in such locations may result in the spread of disease and infections to people, which correspondingly endangers human lives and increases health care costs.

To counter the spread of undesired microorganisms, contaminated surfaces are typically cleaned and sanitized. While this provides an immediate reduction in concentration of microorganisms on given surfaces, the surfaces must be repeatedly cleaned and sanitized on a frequent basis to continue to prevent contamination by microorganisms. Accordingly, there is a need for a durable means for reducing microbial contamination that is easy to use and is effective at reducing microbial contamination over extended periods of time.

Certain antimicrobial compositions on certain substrates or films have been described, for example, in U.S. Pat. No. 8,318,282 (Ylitalo et al.), U.S. Pat. No. 9,247,736 (Ylitalo et al.), U.S. Pat. No. 9,809,717 (Ali et al.) and U.S. Pat. No. 9,828,530 (Ali et al.).

### SUMMARY

The present disclosure provides a composition including an antimicrobial monomer represented by formula CH₂═C(R¹)—C(O)—O-Q-N⁺(R)₂CₙH₂ₙ₊₁(X—), a non-fluorinated crosslinking monomer having at least two acrylate groups, methacrylate groups, or a combination thereof, a polar monomer comprising at least one of acrylic acid, methacrylic acid, or a carboxylate salt thereof, and a nonpolar monomer represented by formula CH₂═C(R¹)—C(O)—O—R². The antimicrobial monomer, the non-fluorinated crosslinking monomer, the polar monomer, and the nonpolar monomer together account for greater than 95 percent by weight, based on the total weight of the composition. In the antimicrobial monomer, R¹ is hydrogen or methyl, Q is alkylene having up to six carbon atoms, each R is independently alkyl having up to four carbon atoms, n is an integer from 1 to 22, and X— is an anion, and in the non-polar monomer, R¹ is hydrogen or methyl and R² is alkyl having from four to 18 carbon atoms. The non-fluorinated crosslinking monomer is present in an amount of greater than 30 percent by weight, based on the total weight of the composition. The polar monomer is present in an amount from 0 percent to 50 percent by weight, based on the total weight of the composition, and the nonpolar monomer is present in an amount from 0 percent to 50 percent by weight, based on the total weight of the composition.

The present disclosure also provides an article including a film having a plurality of pendent groups represented by formula —C(O)—O-Q-N⁺(R)₂CₙH₂ₙ₊₁(X—) covalently bonded in a crosslinked acrylic network. In this formula, Q is alkylene having up to six carbon atoms, each R is independently alkyl having up to four carbon atoms, n is an integer from 1 to 22, and X— is an anion. The crosslinked acrylic network is derived from the composition described above.

The present disclosure further provides an article including a film having a plurality of pendent groups represented by formula —C(O)—O-Q-N⁺(R)₂CₙH₂ₙ₊₁(X—) covalently bonded in a crosslinked non-fluorinated acrylic network. In this formula, Q is alkylene having up to six carbon atoms, each R is independently alkyl having up to four carbon atoms, n is an integer from 1 to 22, and X— is an anion.

The present disclosure further provides a process of making an article. The process includes combining the composition described above with a photoinitiator, coating the resulting composition onto a substrate, and exposing the film to actinic radiation to form a film.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The terms “cure” refers to joining polymer chains together by covalent chemical bonds to form a network polymer. Therefore, in this disclosure the terms “cured” and “crosslinked” may be used interchangeably. A cured or crosslinked polymer is generally characterized by insolubility but may be swellable in the presence of an appropriate solvent. The term “crosslinked network” includes partially crosslinked networks. The term “curable” refers to a polymer that is not yet cured or crosslinked.

The term “microorganism,” “microbe,” or a derivative thereof, is used to refer to any microscopic organism, including without limitation, one or more of bacteria, viruses, algae, fungi and protozoa. In some cases, the microorganisms of particular interest are those that are pathogenic, and the term “pathogen” is used herein to refer to any pathogenic microorganism.

The term “acrylic” refers to both acrylic and methacrylic polymers, oligomers, and monomers.

The term “(meth)acryl” refers to acryl (also referred to in the art as acryloyl and acrylyl) and/or methacryl (also referred to in the art as methacryloyl and methacrylyl).

“Alkyl group” and the prefix “alk-” are inclusive of both straight chain and branched chain groups and of cyclic groups having up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms.

“Alkylene” is the multivalent (e.g., divalent or trivalent) form of the “alkyl” groups defined above.

The term “microstructure” refers to a structure having at least one dimension in a range from one micrometer to one millimeter. For example, a microstructure may have at least one of a height or width that is in a range from one micrometer to one millimeter.

The term “nanostructure” refers to a structure having at least one dimension less than one micrometer. For example, a microstructure may have at least one of a height or width that is less than one micrometer.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

### BRIEF DESCRIPTION OF THE DRAWINGS

FIG. 1 is a perspective view of an embodiment of an article of the present disclosure having a microstructured surface comprising a linear array of prisms;

FIG. 2 is a schematic top-view of irregularly arranged microstructures useful in another embodiment of an article of the present disclosure;

FIG. 3 is a schematic side-view of a microstructure useful in some embodiments of an article of the present disclosure;

FIG. 4 is a schematic side view of an embodiment of an article of the present disclosure comprising a film having microstructures and nanostructures;

FIG. 5 is a schematic side view of substrate having microstructures and nanostructures useful in some embodiments of the article of the present disclosure.

### DETAILED DESCRIPTION

The composition of the present disclosure comprises an antimicrobial monomer represented by formula CH₂═C(R¹)—C(O)—O-Q-N⁺(R)₂CₙH₂ₙ₊₁(X—). In this formula, R¹ is hydrogen or methyl, Q is alkylene having up to six carbon atoms, each R is independently alkyl having up to four carbon atoms, n is an integer from 1 to 22, and X— is an anion. In some embodiments, R¹ is hydrogen. In some embodiments, R¹ is methyl. In some embodiments, Q is alkylene having up to 5, 4, or 3 carbon atoms. In some embodiments, Q is alkylene having from 2 to 6 or 2 to 4 carbon atoms. In some embodiments, each R is independently alkyl having up to 3 or 2 carbon atoms. In some embodiments, each R is methyl. In some embodiments, n is 1. In some embodiments, n is in a range from 4 to 22, 6 to 20, 6 to 18, 8 to 18, 12 to 16, or 14 to 16 carbon atoms. In some embodiments, n is 12, 14, or 16. In some embodiments, the anion X— is a halide anion (e.g., chloride, bromide, fluoride, or iodide) BF₄, N(SO₂CF₃)₂, O₃SCF₃, O₃SC₄F₉, O₄SCH₃, or hydroxide. In some embodiments, X— is chloride. In some embodiments, more than one antimicrobial monomer represented by formula CH₂═C(R¹)—C(O)—O-Q-N⁺(R)₂CₙH₂ₙ₊₁(X—) is present, and each of R, R¹, n, and X— is independently selected. The reactive acrylate or methacrylate group allows the antimicrobial agent to be chemically bonded within the crosslinked acrylic network, while still providing antimicrobial activity to reduce microorganism contamination.

Examples of suitable antimicrobial monomers represented by formula CH₂═C(R¹)—C(O)—O-Q-N⁺(R)₂CₙH₂ₙ₊₁(X—) include trimethylammoniumethylacrylate salts, trimethylammoiniumethylmethacrylate salts, dimethylhexadecylammoniumethylacrylate halides such as dimethylhexadecylammoniumethylacrylate bromide (DMAEA-C16Br), and dimethylhexadecylammoniumethylmethacrylate halides such as dimethylhexadecylammoniumethylmethacrylate bromide (DMAEMA-C16Br). Other antimicrobial monomers are also useful. The chain length n may be selected to allow the chain to move enough within the crosslinked network while also preventing the antimicrobial agent from phase separating from the network, which also depends on the other monomers used to make up the network.

DMAEMA-C16Br and DMAEA-C16Br may be formed by combining a dimethylaminoethyl(meth)acrylate salt, acetone, 1-bromohexadecane, and optionally, an antioxidant and heating. The resultant product may be isolated and purified using conventional techniques, such as those described in the Examples, below.

In some embodiments, the antimicrobial monomer represented by formula CH₂═C(R¹)—C(O)—O-Q-N⁺(R)₂CₙH₂ₙ₊₁(X—) as described above in any of its embodiments is present in the composition in an amount of about 2 weight percent (wt. %) to 50 wt. % based on the total weight of the composition, or at about 5 wt. % to 50 wt. %, about 10 wt. % to 50 wt. %, or at about 15 wt. % to 45 wt. %, or at about 20 wt. % to 45 wt. %, based on the total weight of the composition.

The composition of the present disclosure comprises a non-fluorinated crosslinking monomer having at least two acrylate groups, methacrylate groups, or a combination thereof. In some embodiments, the non-fluorinated crosslinking monomer has at least three acrylate groups, methacrylate groups, or a combination thereof. For example, the non-fluorinated crosslinking monomer can have 4, 5, 6, or more acrylate groups, methacrylate groups, or combinations thereof. Suitable non-fluorinated crosslinking monomers include diacrylate esters of diols, such as ethylene glycol diacrylate, diethylene glycol diacrylate, triethylene glycol diacrylate, tetraethylene glycol diacrylate, propanediol diacrylate, butanediol diacrylate, butane-1,3-diol diacrylate, pentanediol diacrylate, hexanediol diacrylate (including 1,6-hexanediol diacrylate), heptanediol diacrylate, octanediol diacrylate, nonanediol diacrylate, decanediol diacrylate, bisphenol A diacrylate, cyclohexane dimethanol diacrylate, tricyclodecanedimethanol diacrylate, and dimethacrylates of any of the foregoing diacrylates. Further suitable non-fluorinated crosslinking monomers include polyacrylate esters of polyols, such as glycerol diacrylate, glycerol triacrylate, trimethylolpropane diacrylate, trimethylolpropane triacrylate, di-trimethylolpropane tetraacrylate, pentaerythritol triacrylate, pentaerythritol tetraacrylate, neopentyl glycol diacrylate, dipentaerythritol pentaacrylate, triacryloxyethyl isocyanurate, and methacrylates of the foregoing acrylates. Ethoxylated or propoxylated analogues of any of these acrylates or methacrylates are also useful, such as ethoxylated trimethylolpropane triacrylate, ethoxylated (4) bisphenol A dimethacrylate, ethoxylated trimethylolpropane diacrylate, propoxylated (3) glyceryl diacrylate, propoxylated (5,5) glyceryl diacrylate, propoxylated (3) trimethylolpropane diacrylate, propoxylated (6) trimethylolpropane diacrylate), and methacrylate of any of the foregoing acrylates. Many of these non-fluorinated crosslinking monomers are commercially available from multiple sources. Further suitable non-fluorinated crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. Examples of suitable hyperbranched polyester acrylate are those commercially available, from Sartomer Co., Exton, Pa., under the trade designations “CN2300”, “CN2301”, “CN2302”, “CN2303”, and “CN2304”. Other examples of suitable (meth)acrylated urethanes and polyesters include oligomers commercially available under the trade designation “PHOTOMER” from Henkel Corp., Hoboken, N.J.; oligomers commercially available under the trade designation “EBECRYL” from UCB Radcure Inc., Smyrna, Ga.; oligomers commercially available under the trade designation “ACTILANE” from Akcross Chemicals, New Brunswick, N.J.; and oligomers commercially available under the trade designation “UVITHANE” from Morton International, Chicago, Ill. A combination of any of these non-fluorinated crosslinking monomers may be used.

The non-fluorinated crosslinking monomer(s) is present in an amount of greater than 30 wt. %, based on the total weight of the composition. In some embodiments, the non-fluorinated crosslinking monomer is present in an amount of at least 31 wt. %, 32 wt. %, 33 wt. %, 34 wt. %, or 35 wt. %, based on the total weight of the composition. In some embodiments, the non-fluorinated crosslinking monomer is present in a range from greater than 30 wt. % to 65 wt. %, from 31 wt. % to 60 wt. %, from 35 wt. % to 60 wt. %, or from 40 wt. % to 55 wt. %, based on the total weight of the composition.

In some embodiments, the composition of the present disclosure includes a polar monomer comprising at least one of acrylic acid, methacrylic acid, or a carboxylate salt thereof, or a blend thereof. In some embodiments, the polar monomer is acrylic acid, methacrylic acid, or a combination thereof. In some embodiments, the acid is converted either before polymerization to a corresponding carboxylate salt by neutralization. The carboxylate salt may be any alkali metal salt or a zinc salt, for example. In some embodiments, the acrylic acid, methacrylic acid, or a salt thereof is a mixture of two or more thereof.

The polar monomer is included in the composition in an amount from 0 wt. % to 50 wt. % based on the total weight of the composition. In some embodiments, the polar monomer is present in an amount of at least 2 wt. %, 5 wt. %, 6 wt. %, 8 wt. %, 10 wt. %, 15 wt. %, or 20 wt. % based on the total weight of the composition. In some embodiments, the polar monomer is present in an amount of about 2 wt. % to 45 wt. %, 5 wt. % to 40 wt. %, 5 wt. % to 35 wt. %, or 10 wt. % to 30 wt. %, based on the total weight of the composition.

In some embodiments, the composition of the present disclosure includes a nonpolar monomer represented by formula CH₂═C(R¹)—C(O)—O—R². In this formula, R¹ is hydrogen or methyl, and R² is independently alkyl having from four to 18 carbon atoms. In some embodiments, R¹ is methyl. R² can be linear, branched, cyclic, or a combination thereof. In some embodiments, R² has from 6 to 18, 4 to 16, 6 to 12, 4 to 12, or 8 to 12 carbon atoms. Examples of suitable monomers represented by formula CH₂═C(R¹)—C(O)—O—R² include isobutyl acrylate, n-butyl acrylate, n-hexyl acylate, octyl acrylate, isooctyl acrylate, nonyl acrylate, isononyl acrylate, decyl acrylate, isodecyl acrylate, undecyl acrylate, dodecyl acrylate, isobornyl acrylate, lauryl acrylate, stearyl acrylate, and methacrylates of the foregoing acrylates. In some embodiments, the nonpolar monomer represented by formula CH₂═C(R¹)—C(O)—O—R² is a mixture of two or more such compounds.

The nonpolar monomer represented by formula CH₂═C(R¹)—C(O)—O—R² is included in the composition in an amount from 0 wt. % to 50 wt. % based on the total weight of the composition. In some embodiments, the nonpolar monomer is present in an amount of at least 2 wt. %, 5 wt. %, 6 wt. %, 8 wt. %, 10 wt. %, 15 wt. %, or 20 wt. % based on the total weight of the composition. In some embodiments, the polar monomer is present in an amount of about 2 wt. % to 49 wt. %, 2 wt. % to 45 wt. %, 5 wt. % to 40 wt. %, 5 wt. % to 35 wt. %, or 10 wt. % to 30 wt. %, based on the total weight of the composition. In some embodiments the amount of the nonpolar monomer in the composition is 0% by weight.

In some embodiments of the composition of the present disclosure, the antimicrobial monomer, the non-fluorinated crosslinking monomer, the polar monomer (if present), and the nonpolar monomer (if present) together account for greater than 95, 96, 97, or 98 percent by weight, based on the total weight of the composition. In some embodiments, the non-fluorinated crosslinking monomer is present in an amount of at least 35 percent by weight, the polar monomer is present in an amount of at least 25 percent by weight, and the nonpolar monomer is present in an amount of 0 percent by weight, based on the total weight of the composition. In some these embodiments, the antimicrobial monomer represented by formula CH₂═C(R¹)—C(O)—O-Q-N⁺(R)₂CₙH₂ₙ₊₁(X—) as described above in any of its embodiments is present in the composition in an amount of about 2 weight percent (wt. %) to 40 wt. % based on the total weight of the composition, or at about 5 wt. % to 39.5 wt. %, about 10 wt. % to 39 wt. %, or at about 15 wt. % to 35 wt. %, or at about 20 wt. % to 35 wt. %, based on the total weight of the composition.

In some embodiments of the composition of the present disclosure, polymerizable monomers other than the antimicrobial monomer, the non-fluorinated crosslinking monomer, the polar monomer, and the nonpolar monomer are present in the composition. Examples of suitable polymerizable monomers include styrene, alpha-methylstyrene, substituted styrene, vinyl esters, vinyl ethers, N-vinyl-2-pyrrolidone, (meth)acrylamide, N-substituted (meth)acrylamide, nonylphenol ethoxylate (meth)acrylate, 2-(2-ethoxyethoxy)ethyl (meth)acrylate, beta-carboxyethyl (meth)acrylate, cycloaliphatic epoxide, alpha-epoxide, 2-hydroxyethyl (meth)acrylate, (meth)acrylonitrile, maleic anhydride, itaconic acid, methyl (meth)acrylate, N-vinylcaprolactam, hydroxy functional caprolactone ester (meth)acrylate, hydroxyethyl (meth)acrylate, hydroxymethyl (meth)acrylate, hydroxypropyl (meth)acrylate, hydroxyisopropyl (meth)acrylate, hydroxybutyl (meth)acrylate, hydroxyisobutyl (meth)acrylate, and tetrahydrofurfuryl (meth)acrylate. In some embodiments, if these are polymerizable monomers are present, they are present in less than 5, 4, 3, 2, or 1 percent by weight, based on the total weight of the composition.

While inorganic oxide fillers may provide beneficial properties in some cases, they tend to absorb part of the incident radiation during a curing process, thereby depleting the available energy to activate the curing agents. They also can result in poor optical clarity in the article comprising a film of the present disclosure. In some embodiments, if inorganic oxide fillers are present, they are present in less than 5, 4, 3, 2, or 1 percent by weight, based on the total weight of the composition. In some embodiments, if silica nanoparticles are present, they are present in less than 5, 4, 3, 2, or 1 percent by weight, based on the total weight of the composition. In some embodiments, the composition of the present disclosure is free of inorganic oxide fillers.

In some embodiments, the composition of the present disclosure includes one or more photoinitiators. Any suitable first and second photoinitiators may be used. Suitable photoinitiators may include type I or type II photoinitiators. Suitable photoinitiators may include hydroxyacetophenones, benzilketal, alkylaminoacetophenones, benzoyl phosphine oxides or phosphinates, benzoin ethers, benzophenones, and benzoylformate esters. Examples of suitable acetophenone compounds include 4-diethylaminoacetophenone, 1-hydroxycyclohexyl phenyl ketone, 2-benzyl-2 dimethylamino-4′-morpholinobutyrophenone, 2-hydroxy-2-methyl-1-phenylpropan-I one, and 2,2-dimethoxy-1,2-diphenylethan-1-one. Examples of suitable phosphine oxide compounds include phenyl bis(2,4,6-trimethylbenzoyl)-phosphine oxide, 2,4,6-trimethylbenzoyldiphenylphosphine oxide, and 2,4,6-trimethylbenzoylphenylethoxyphosphine oxide.

Specific examples include photoinitiators sold under the trade names “ESACURE KIP150”, “ESACURE ONE”, “OMNIRAD 1173”, “OMNIRAD 651”, “OMNIRAD TPO”, “OMNIRAD TPO-1”, “OMNIRAD 819”, “OMNIRAD 184”, “OMNIRAD 2950”, “OMNIRAD 369”, “OMNIRAD 907”, “IRGACURE”, and “DAROCUR”. Co-initiators and photosensitizers may be included.

Suitable amounts of photoinitiators range from about 0.05% by weight to less than 5% by weight, or from about 0.1% by weight to about 2% by weight, based on the total weight of the composition.

The composition may also include optional additives, such as heat stabilizers, ultraviolet light stabilizers, fragrances, free-radical scavengers, dyes, pigments, surfactants, and combinations thereof. Examples of suitable commercially available ultraviolet light stabilizers those available under the trade designation “UVINOL” from BASF Corp., Parsippany, N.J.; under the trade designation “CYASORB” from Cytec Industries, West Patterson, N.J.; and under the trade designation “TINUVIN” from Ciba Specialty Chemicals, Tarrytown, N.Y. Examples of suitable concentrations of ultraviolet light stabilizers in the composition range from about 0.1% by weight to less than 5% by weight, with particularly suitable total concentrations ranging from about 1% by weight to about 30% by weight, based on the total weight of the composition.

Examples of suitable free-radical scavengers include hindered amine light stabilizer (HALS) compounds, hydroxylamines, sterically hindered phenols, and combinations thereof. Examples of suitable commercially available HALS compounds include the trade designated “TINUVIN 292” from Ciba Specialty Chemicals, Tarrytown, N.Y., and the trade designated “CYASORB UV-24” from Cytec Industries, West Patterson, NJ. Examples of suitable concentrations of free-radical scavengers in the composition range from about 0.05% by weight to about 0.25% by weight, based on the total weight of the composition.

Examples of suitable surfactants include anionic, cationic, non-ionic, and zwitterionic surfactants and emulsifiers, such as those disclosed in Scholz et al., U.S. Pat. No. 5,951,993. Examples of suitable surfactants include polyalkoxylated block copolymer surfactants, silicone copolyols, polyethylene oxide alkyl and/or aryl ethers and esters, and combinations thereof.

The composition of the present disclosure may also include one or more other inorganic or organic antimicrobial agents that is effective for reducing or retarding contamination by microorganisms.

The antimicrobial performance of the film in the article of the present disclosure may be increased by incorporating another antimicrobial agent into the crosslinked network. For example, the antimicrobial monomer represented by formula CH₂═C(R¹)—C(O)—O-Q-N⁺(R)₂CₙH₂ₙ₊₁(X—) provides faster antimicrobial activity against gram (+) bacteria, while silver compounds show slower but broader antimicrobial activity against both gram (+) and gram (−) bacteria, viruses, and fungi.

Examples of suitable inorganic antimicrobial agents include transition metal ion-based compounds, (e.g., silver, zinc, copper, gold, tin and platinum-based compounds). Examples of suitable silver-containing antimicrobial agents include silver sulfate, silver acetate, silver chloride, silver lactate, silver phosphate, silver stearate, silver thiocyanate, silver proteinate, silver carbonate, silver nitrate, silver sulfadiazine, silver alginate, silver nanoparticles, silver-substituted ceramic zeolites, silver complexed with calcium phosphates, silver-copper complexed with calcium phosphates, silver dihydrogen citrates, silver iodines, silver oxides, silver zirconium phosphates, silver-substituted glass, and combinations thereof. The other antimicrobial agent may be present in the composition in a range from about 1% by weight to less than about 5% by weight, based on the total weight of the composition.

The present disclosure provides an article comprising a film comprising a plurality of pendent groups represented by formula —C(O)—O-Q-N⁺(R)₂CₙH₂ₙ₊₁(X—) covalently bonded in a crosslinked acrylic network, wherein Q, R, n and X′— are as defined above in any of their embodiments. In some embodiments, the crosslinked acrylic network is derived from the composition described above in any of its embodiments. The crosslinked network may be a non-fluorinated crosslinked acrylic network.

An acrylic network is made by the addition polymerization of acrylate and/or methacrylate groups. Acrylic networks can be identified, for example, by Raman and Infrared Spectroscopy and other solid state spectroscopic techniques. The film is not crosslinked by condensation of silane groups to form polysiloxane bonds. The composition of the present disclosure can be free of silanes, and the film in the article of the present disclosure may be free of polysiloxane bonds.

In some embodiments, the process of making the article of the present disclosure includes providing the composition of the present disclosure that includes a photoinitiator, coating the composition onto a substrate, and exposing the composition to actinic radiation to form a film. Before adding the photoinitiator in any of its embodiments described above, the composition may be as described above in any of its embodiments.

Coating may be performed in a variety of manners, such as rod coating, knife coating, curtain coating, gravature coating, roll coating, slot or die coating, dip coating, spray coating, extrusion processes, and wet casting processes. Typically, the composition does not include solvent and can be coated in the absence of solvent. If a solvent (e.g., water, alcohols (e.g., ethanol and isopropanol), ketones (e.g., methyl ethyl ketone, cyclohexanone, and acetone), aromatic hydrocarbons, isophorone, butyrolactone, N-methylpyrrolidone, tetrahydrofuran, esters (e.g., lactates and acetates such as propylene glycol monomethyl ether acetate, diethylene glycol ethyl ether acetate, ethylene glycol butyl ether acetate, dipropylene glycol monomethyl acetate), iso-alkyl esters (e.g., isohexyl acetate, isoheptyl acetate, isooctyl acetate, isononyl acetate, isodecyl acetate, isododecyl acetate, isotridecyl acetate), and combinations thereof) is present in the composition, the coated film may then be dried to remove the solvent.

The actinic radiation useful for polymerizing a crosslinking the composition can include radiation having a wavelength in the ultraviolet (e.g., 10 nm to 400 nm) or visible (e.g., 380 to 700 nm) region of the spectrum and accelerated particles (e.g., electron beam radiation). Suitable sources of actinic radiation include mercury lamps, xenon lamps, carbon arc lamps, tungsten filament lamps, lasers, electron beam energy, and sunlight. A suitable commercially available ultraviolet-radiation system is a Fusion Systems UV Processor, Model MC6RQN, which is commercially available from Fusion UV Systems, Gaithersburg, MD. In some embodiments, the light source is a narrow band light source, such as an LED or a laser. In some embodiments, the light source is a broad band light source such as a fluorescent UV bulb or a mercury lamp. The selection of the light source and the selection of the photoinitiator can be carried out to choose the most effective photoinitiator for the light source, and vice versa. The film may undergo one or more passes through the UV Processor to ensure substantial polymerization of the composition. The total radiation dose applied can be determined by the type of radiation source used and the thickness of coating of the composition. If electron beam radiation is used as the source of actinic radiation, the composition can be cured in the absence of a photoinitiator.

The film in the article of the present disclosure a plurality of pendent groups represented by formula —C(O)—O-Q-N⁺(R)₂CₙH₂ₙ₊₁(X—) covalently bonded in a crosslinked acrylic network, which may substantially prevent or retard the pendent groups from being washed out of the film. Additionally, the crosslinked network imparts physical durability to the film. Durability is particularly beneficial for use with surfaces that are continuously subjected to wear and scratching. In some embodiments, the film in the article of the present disclosure is a thin, transparent film, which allows the film to be applied to surfaces without detracting from the visual and topographical characteristics of the surfaces. For example, the film may be laminated on ornamental objects without detracting from their aesthetic qualities. Additionally, the film may be suitable for display applications, such as touch-screen displays. Alternatively, the film may be a colored, transparent film and may be printed or otherwise decorated with patterns and/or alphanumeric characters to impart information. The film may have any desirable thickness. For example, in some embodiments, the thickness of the film is in a range from about 1 micrometer to about 250 micrometers, about 1 micrometer to about 150 micrometers, about 1 micrometer to about 100 micrometers, about 1 micrometer to about 25 micrometers, in some embodiments, about 5 micrometers to about 15 micrometers.

In some embodiments, the article of the present disclosure includes a substrate onto which the film described herein in any of its embodiments is disposed. Depending on particular applications, the substrate may be rigid, semi-rigid, or flexible/conformable. Suitable materials for the substrate include any rigid, semi-rigid, and conformable polymeric materials, such as thermoplastic materials (e.g., polyolefins and polyethylene terephthalates). Further examples of suitable substrates include styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, polyimides, silicone and fluorinated films, and glass. Optionally, the substrate can contain mixtures or combinations of these materials. In an embodiment, the substrate may be multi-layered or may contain a dispersed component suspended or dispersed in a continuous phase. Examples of useful polyolefins include low-density polyethylene (LDPE), medium-density polyethylene (MDPE), high-density polyethylene (HDPE), polymethylpentene (PMP), cyclic olefin polymer (COP), cyclic olefin copolymer (COC), and polypropylene. An example of a useful PET films include photograde polyethylene terephthalate and MELINEX™ PET available from DuPont Films of Wilmington, Del. An example of a useful thermoformable material is polyethylene terephthalate (polyester with glycol) commercially available as VIVAK PETG. Such material is characterized by having a tensile strength ranging from 5000-10,000 psi (ASTM D638) and a flexural strength of 5,000 to 15,000 (ASTM D-790). Such material has a glass transition temperature of 178° F. (ASTM D-3418). The substrate may also be a release liner.

In some embodiments, the substrate is a fluoropolymer. Examples of useful fluoropolymers include polyvinylidene fluoride (PVDF), copolymers of vinylidene fluoride (CoPVDF) including copolymers of vinylidene fluoride and hexafluoropropylene, copolymers of hexafluoropropylene, tetrafluoroethylene, and ethylene (HTE), copolymers of tetrafluoroethylene and ethylene (ETFE), copolymers of hexafluoropropylene and tetrafluoroethylene (FEP), copolymers of chlorotetrafluoroethylene and ethylene (ECTFE), and copolymers of tetrafluoroethylene, vinylidene fluoride, and hexafluoropropylene (THV), and combinations of any of these.

In some embodiments, the substrate is a thin-layer thermoplastic material that is optically transparent. The substrate may be primed or otherwise treated to promote adhesion to the film described herein (e.g., acrylic priming and corona treatments). When flexible/conformable materials are used for the substrate, the film may be adhered to a variety surface dimensions (e.g., planar and curved surfaces). Additionally, this conformability allows the article of the present disclosure to be wound up and provided as a roll.

In some embodiments, the substrate may include multiple layers of the same or different substrate materials. The substrate may provide a variety of optical enhancement properties, such as antiglare, antifog, light polarization, limited or expanded optical wavelength transmission, reflectivity, and combinations thereof.

Referring again to the process for making the article, the composition including an antimicrobial monomer and a non-fluorinated crosslinking monomer as described above in any of their embodiments can be coated on a primed substrate and covered with a liner. The resulting construction can be passed through a laminator to create a uniform sample. The coated composition sandwiched between the substrate and the liner can be passed through a UV processor as described above to form the non-fluorinated crosslinked network. The liner may be removed.

In some embodiments, the film in the article of the present disclosure comprises microstructures, nanostructures, or combinations thereof. In some embodiments, the microstructures, nanostructures, or combinations thereof comprise at least one of continuous peaks and adjacent valleys, pyramids (e.g., square, triangular, or having another polygonal base), cones, truncated pyramids or cones, hemispherical bumps, dome-shaped bumps, ellipsoidal bumps, upstanding posts or cylinders, or cube corners. The microstructures, nanostructures, or combinations thereof may be in the form of protrusion or depressions in the film having any of these shapes. The film may be imparted with microstructures, nanostructures, or combinations thereof by a substrate on which it is disposed, or the film may have microstructures, nanostructures, or combinations thereof while being disposed on a planar substrate or a substrate otherwise not provided with the microstructures, nanostructure, or combinations thereof.

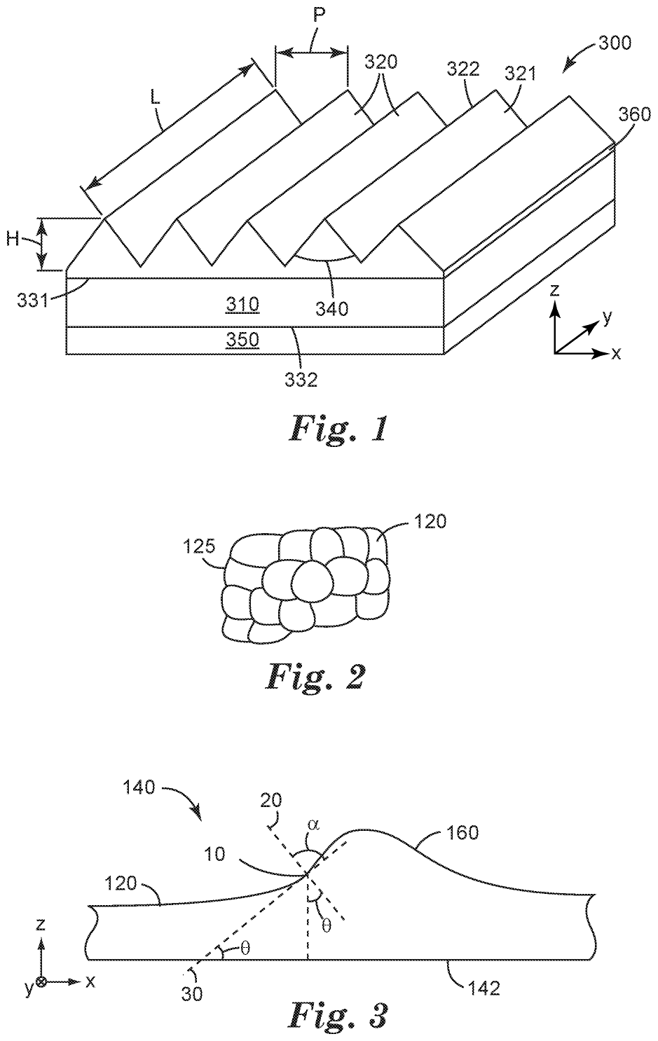

In the embodiment illustrated in FIG. 1, a film in the article of the present disclosure has a microstructured or nanostructured surface 300 comprising a linear array of regular prisms 320. Each prism has a first facet 321 and a second facet 322. In the illustrated embodiment, the film is disposed on a substrate 310 that has a first planar surface 331 on which the prisms 320 are formed and a second surface 332 that is substantially flat or planar and opposite first surface. The apex angle 340 can have a wide range of values. For a reflective surface apex angle 340 can be at least 60°, 65°, 70°, 75°, 80°, or 85°. In some embodiments, the apex angle 340 can be at most 150°, 145°, 140°, 135°, 130°, 125°, 120°, 110°, or 100°. For an anti-reflective surface, apex angle 340 can be not more than 110°, 100°, 95°, 90°, 85°, 80°, 75°, 70°, 65°, 60°, or 55° and is typically at least 25°, 30°, 35°, 40°, 45°, or 50°. The apexes of the prisms can be sharp (as shown), rounded (not shown), or truncated (not shown). The spacing between (e.g. prism) peaks may be characterized as pitch (“P”). In this embodiment, the pitch is also equal to the maximum width of the valley. In some embodiments, the pitch is greater than 1, 2, 3, 4, 5, 6, 7, 8, 9, or 10 microns ranging up to 250 microns. The length (“L”) of the (e.g. prism) structures is typically the largest dimension and can span the entire dimension of the structured surface, film, or article. The prism facets need not be identical in height “H” or apex angle 340, and the prisms may be tilted with respect to each other. The “H” of the (e.g., prism) structures may also change along their lengths.

As shown in FIG. 1, a continuous land layer 360 can be present between the bottom of the channels or valleys and the top surface 331 of (e.g. planar) substrate 310. In some embodiments, the thickness of the land layer 360 is typically at least 0.5, 1, 2, 3, 4, or 5 microns ranging up to 50 microns. In some embodiments, the thickness of the land layer is no greater than 45, 40, 35, 30, 25, 20, 15, or 10 microns.

In some embodiments, including the embodiment illustrated in FIG. 1, the microstructures or nanostructures can form a regular pattern. In some embodiments, the microstructures or nanostructures form an irregular arrangement. For example, FIG. 2 is a schematic top-view of structures 120 in an irregular arrangement 125 of rounded protrusions. In some cases, structures can form a pseudo-random pattern that appears to be random. When the structured surface is prepared as a roll-good from a cylindrical tool, as described in further detail below, the structured roll-good has a repeating pattern corresponding to a revolution of the tool or a smaller dimension if the pattern repeats on the tool surface. If one were to inspect a structured article fabricated from such tool, wherein the article has a dimension smaller than the repeat pattern, the repetition of the pattern may not be evident, and the structures would appear random.

In some embodiments, a (e.g. discrete) microstructure or nanostructure can be characterized by slope. FIG. 3 is a schematic side-view of a portion of a structured film 140. In particular, FIG. 3 shows a microstructure 160 in major surface 120 and opposing (e.g. planar) major surface 142. Microstructure 160 has a slope distribution across the surface of the microstructure. For example, the microstructure has a slope θ at a location 10 where θ is the angle between normal line 20 which is perpendicular to the microstructure surface at location 10 (α=90 degrees) and a tangent line 30 which is tangent to the microstructure surface at the same location. Slope θ is also the angle between tangent line 30 and opposing major surface 142. The F_{cc}(θ) complement cumulative slope magnitude distribution of the slope distribution can be determined by phase shifting interferometry and is defined by the following equation

$${F}_{CC} ( θ ) = \frac{{\sum }_{q = θ}^{∞} {N}_{G} ( q )}{{\sum }_{q = 0}^{∞} {N}_{G} ( q )} .$$

F_{cc} at a particular angle (θ) is the fraction of the slopes that are greater than or equal to θ. Further details about the measurement method can be found, for example, in U.S. 2013/0236697 (Walker et al.). In some embodiments, at least 90% or greater of the microstructures have a F_{cc}(θ) complement cumulative slope magnitude of at least 0.1 degrees or greater. In some embodiments, at least 75% of the microstructures have a slope magnitude of at least 0.3 degrees. In some embodiments, at least 25% or 30% or 35% or 40% or 45% or 50% or 55% or 60% or 65% or 70% or 75% of the microstructures have a slope magnitude of at least 0.7 degrees. Thus, at least 25% or 30% or 35% or 40% or 45% or 50% or 55% or 60% or 65% or 70% can have a slope magnitude less than 0.7 degrees. In some embodiments, at least 25% of the microstructures having a slope magnitude of less than 1.3 degrees. In some embodiments, at least 30%, or 35%, or 40%, or 45% of the microstructures have a slope magnitude of at least 1.3 degrees. Hence, 55% or 60% or 65% of the microstructures can have a slope magnitude less than 1.3 degrees. In some embodiments, at least 5% or 10% or 15% or 20% of the microstructures have a slope magnitude of at least 1.3 degrees. Hence, 80% or 85% or 90% or 95% of the microstructures can have a slope magnitude less than 1.3 degrees. In some embodiments, less than 20% or 15% or 10% of the microstructures have a slope magnitude of 4.1 degrees or greater. Thus, 80% or 85% or 90% can have a slope magnitude less than 4.1 degrees. In some embodiments, 5% to 10% of the microstructures have a slope magnitude of 4.1 degrees or greater. In some embodiments, less than 5% or 4% or 3% or 2% or 1% of the microstructures have a slope magnitude of 4.1 degrees or greater.

In some embodiments of the article of the present disclosure, the microstructures or nanostructures have geometrical symmetry and asymmetric slope distribution, wherein no more than about 7% of the structured major surface has a slope magnitude greater than about 3.5 degrees or no more than about 4% of the structured major surface has a slope magnitude greater than about 5 degrees. In some embodiments of the article of the present disclosure, the microstructures or nanostructures have geometrical asymmetry and symmetric slope distribution, wherein no more than about 7% of the structured major surface has a slope magnitude greater than about 3.5 degrees or no more than about 4% of the structured major surface has a slope magnitude greater than about 5 degrees. Examples of suitable structured surfaces of the substrate or the film also include those described in U.S. Pat. No. 9,229,239 (Aronson et al.).

In the embodiments illustrated in FIGS. 1 and 2, the microstructures or nanostructures make up substantially the entire surface of the film (e.g., at least 95%, 96%, 97%, 98%, or 99% of the surface of the film). The structures may be said to be continuous on the surface of the film. In other embodiments, such as the embodiment shown in FIG. 5, the structures may be spaced apart on the surface of the film. In some embodiments, microstructures, nanostructures, or combinations thereof cover at least about 25%, 30%, 35% 40%, 45%, 50%, 55%, 60%, 65%, 70%, or 75% of a surface of the film. In some embodiments, microstructures, nanostructures, or combinations thereof cover not more than about 95%, 90%, 85%, 80%, 75%, 70%, 65%, 60%, 55%, or 50% of a surface of the film. Spaces between microstructure, for example, having a planar surface between microstructures or a nanostructured surface between microstructures may be useful, for example, for influencing fluid flow on the film.

The size, shape, and spacing of the microstructures or nanostructures may be selected based on the desired properties of the film. For example, the structures may be selected for desirable optical properties such as reflectivity or anti-reflectivity. Int. Pat. Appl. Publ. No. WO2013/003373 (Bommarito et al.) describes that structures having a cross-sectional dimension no greater than 5 microns are believed to substantially interfere with the settlement and adhesion of target bacteria. Int. Pat. Appl. Serial No. PCT/IB2020/057840 (Connell et al.), filed Aug. 20, 2020, describes microstructured surfaces that are easy to clean.

Microstructures may have a height (H) ranging from 1 to 125 microns measured from, for example, as shown in FIG. 1, a continuous land layer 360 or from a second major surface of the film opposite the first surface bearing the microstructures. In some embodiments, the height of the microstructures is at least 2, 3, 4, or 5 microns. In some embodiments, the height of the microstructures is at least 6, 7, 8, 9 or 10 microns. In some embodiments, the height of the microstructures no greater than 100, 90, 80, 70, 60, or 50 microns. In some embodiments, the height of the microstructures is no greater than 45, 40, 35, 30 or 25 microns. In some embodiments, the height of the microstructures is no greater than 24, 23, 22, 21, 20, 19, 18, 17, 16, 15, 14, 13, 12, 11, or 10 microns. In some embodiments, nanostructures may have a height of at least 100 nanometers (nm) or 200 nm. In some embodiments, the height of the valley or channel between microstructures is within the same range as just described for the microstructures. In some embodiments, peak structures and valleys have the same height.

Further examples of suitable structured surfaces of the substrate or the film are those described in Int. Pat. Appl. Serial No. PCT/IB2020/057840 (Connell et al.), filed Aug. 20, 2020.

Referring again to the process for making the article, the composition including an antimicrobial monomer and a non-fluorinated crosslinking monomer as described above in any of their embodiments can be coated on a primed substrate and placed against a film tool having microstructures, nanostructures, or combinations thereof. The resulting construction can be passed through a laminator to create a uniform sample. The coated composition sandwiched between the substrate and the structured film tool can be passed through a UV processor as described above to form the non-fluorinated crosslinked network. The primed substrate with the crosslinked network can be removed from the structured film tool to provide a film with a surface comprising microstructures, nanostructures, or combinations thereof.

In another example, as described in Lu et al., U.S. Pat. No. 5,175,030, and Lu, U.S. Pat. No. 5,183,597, a microstructure-bearing article can be prepared by a method including (a) preparing a polymerizable composition; (b) depositing the polymerizable composition onto a master negative microstructured molding surface in an amount barely sufficient to fill the cavities of the master; (c) filling the cavities by moving a bead of the polymerizable composition between a preformed substrate (such as a monolithic or multilayer e.g. PET film) and the master, at least one of which is flexible; and (d) curing the composition. The master can be metallic, such as nickel, nickel-plated copper or brass, or can be a thermoplastic material that is stable under the polymerization conditions and may have a surface energy that allows clean removal of the polymerized material from the master. One or more the surfaces of the substrate can optionally be primed or otherwise be treated to promote adhesion of the optical layer to the substrate. In some embodiments, sufficient composition can be deposited on the master to provide a coherent film, which may be removed from the tool.

A surface including microstructures, nanostructures, or combinations thereof can be formed by use of a tool fabricated by any available method, such as engraving, diamond turning, etching (e.g., chemical etching, mechanical etching, or other ablative means such as laser ablation or reactive ion etching, and combinations thereof), photolithography, stereolithography, micromachining, knurling (e.g., cutting knurling or acid enhanced knurling), scoring, cutting, and combinations thereof. Diamond Turning Machines (DTM) can be used to generate microreplication tools for creating a variety of structures. Examples of diamond turning machines and methods for creating discontinuous, or non-uniform, surface structures can include and utilize a fast tool servo (FTS) as described in, for example, PCT Pub. No. WO 00/48037, published Aug. 17, 2000; U.S. Pat. No. 7,350,442 (Ehnes et al.) and U.S. Pat. No. 7,328,638 (Gardiner et al.); and U.S. Pat. Pub. No. 2009/0147361 (Gardiner et al.). A microstructured surface further comprising nanostructures can be formed by use of a multi-tipped diamond tool as described in U.S. Pat. Pub. No. 2013/0236697 (Walker et al.). The multi-tipped diamond tool may have a single radius, wherein the plurality of tips has a pitch of less than 1 micrometer. The tips are adjacent to one another and form a valley between the tips. Each tip of the diamond tool defines a separate cutting mechanism. Focused ion beam milling processes can be used to form the tips and may also be used to form the valley of the diamond tool. For example, focused ion beam milling can be used to ensure that inner surfaces of the tips meet along a common axis to form a bottom of valley. Focused ion beam milling can be used to form features in the valley, such as concave or convex arc ellipses, parabolas, mathematically defined surface patterns, or random or pseudo-random patterns. A wide variety of other shapes of valley could also be formed.

In some embodiments, nanostructures may be formed with a microreplication tool further having a nanostructured granular plating for embossing. Electrochemical deposition, for example, can be used to generate various surface structures including nanostructures in a microreplication tool. The tool may be made using a two-part electroplating process, wherein a first electroplating procedure may form a first metal layer with a first major surface, and a second electroplating procedure may form a second metal layer on the first metal layer. The second metal layer may have a second major surface with a smaller average roughness than that of the first major surface. The second major surface can function as the structured surface of the tool. An example of an electrochemical deposition technique is described in U.S. Pat. Appl. Pub. No. 2020/0064525 (Derks et al.).

As described above, the composition of the present disclosure including an antimicrobial monomer and a non-fluorinated crosslinking monomer as described above in any of their embodiments can be placed against a film tool having microstructures, nanostructures, or combinations thereof and then cured to form the non-fluorinated crosslinked network in the form of a film having microstructures, nanostructures, or combinations thereof, which is removed from the film tool. A diamond turning machine can also be used to form a substrate having a surface with microstructures, nanostructures, or combinations thereof onto which the composition of the present disclosure is coated and cured to form an article of the present disclosure in which the substrate having the structured surface is part of the article. Thermoplastic substrates can also be provided with microstructured surfaces, for example, by extruding a thermoplastic through a nip formed at least in part by a tool roll made by any of the methods described above or by embossing with such a tool.

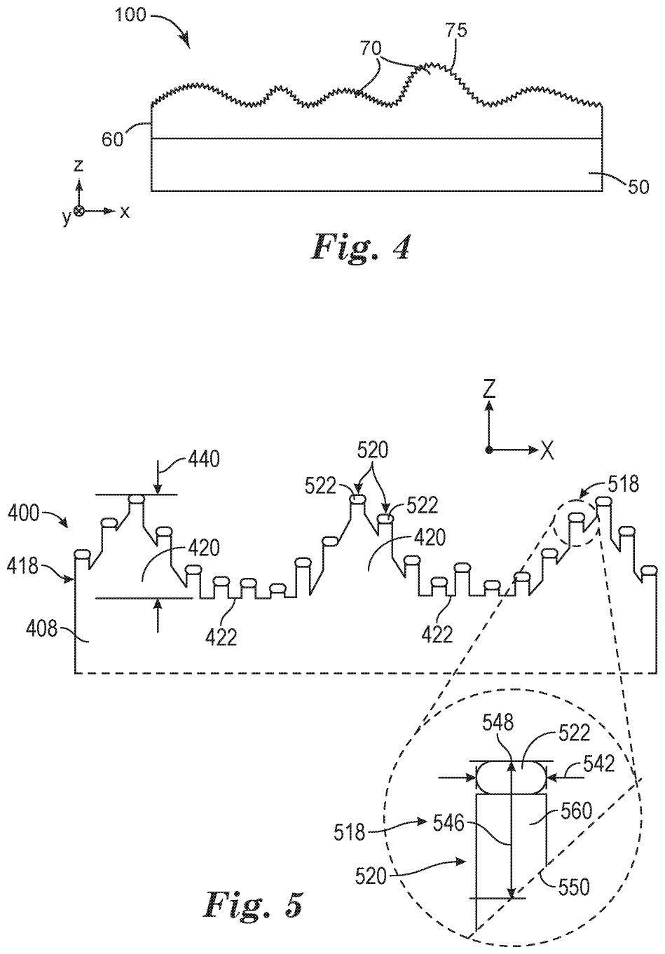

FIGS. 4 and 5 illustrate surfaces having both microstructures and nanostructures. FIG. 4 illustrates an embodiment of an article of the present disclosure 100 comprising a film 60 having a microstructured surface disposed on a substrate 50. Film 60 further comprises a plurality of nanostructures 75. The nanostructures 75 may be characterized as being on or embedded within the micro-structured surface of film 60.

FIG. 5 shows cross section 400 of a substrate 408 having surface comprising microstructures and nanostructures. In the illustrated embodiment, microstructures 418 of substrate 408 form a skipped tooth riblet pattern of alternating micro-peaks 420 and micro-spaces 422.

Nanostructures 520 in FIG. 5 may be formed, for example, using masking elements 522. For example, masking elements 522 may be used in a subtractive manufacturing process, such as reactive ion etching (RIE), to form nanostructures 520 on a surface having microstructures 418. A method of making a nanostructured substrate may involve depositing a layer to a major surface of a substrate, such as layer 408, by plasma chemical vapor deposition from a gaseous mixture and subsequently or substantially simultaneously etching the surface with a reactive species. The method may include providing a substrate, mixing a first gaseous species capable of depositing a layer onto the substrate when formed into a plasma, with a second gaseous species capable of etching the substrate when formed into a plasma, thereby forming a gaseous mixture. The method may include forming the gaseous mixture into a plasma and exposing a surface of the substrate to the plasma, wherein the surface may be etched, and a layer may be deposited on at least a portion of the etched surface sequentially or substantially simultaneously, thereby forming the nanostructure.

The substrate can be a polymeric material, an inorganic material, an alloy, a solid solution, or a combination thereof. The deposited layer can include the reaction product of plasma chemical vapor deposition using a reactant gas comprising a compound selected from the group consisting of organosilicon compounds, metal alkyl compounds, metal isopropoxide compounds, metal acetylacetonate compounds, metal halide compounds, and combinations thereof. Nanostructures of high aspect ratio, and optionally with random dimensions in at least one dimension, and even in three orthogonal dimensions, can be prepared.

A series of nano-sized masking elements 522 may be disposed on at least micro-spaces 422. The surface of substrate 408 may be exposed to reactive ion etching to form plurality of nanostructures 518 on the surface of the layer including series of nano-peaks 520. Each nano-peak 520 may include masking element 522 and column 560 of layer material between masking element 522 and substrate 408.

Masking element 522 may be formed of any suitable material more resistant to the effects of RIE than the material of substrate 408. In some embodiments, masking element 522 includes an inorganic material. In some embodiments, the masking element 522 is hydrophilic. Examples of inorganic, hydrophilic materials include silica and silicon dioxide. Each masking element 522 may define maximum diameter 542. As used herein, the term “maximum diameter” refers to a longest dimension based on a straight line passing through an element having any shape. In some embodiments, the maximum diameter of masking element 522 may be at most 1000 (in some embodiments, at most 750, 500, 400, 300, 250, 200, 150, or even at most 100) nanometers. Maximum diameter 542 of each masking element 522 may be described relative to micro-peak height 440 of corresponding micro-peak 420. In some embodiments, corresponding micro-peak height 440 is at least 10 (in some embodiments, at least 25, 50, 100, 200, 250, 300, 400, 500, 750, or even at least 1000) times maximum diameter 542 of masking element 522. Each nano-peak 520 may be defined by a height 546, which is the distance between baseline 550 and the apex 548 of masking element 522.

Substrate 408, made by this method, for example, can be coated with the composition of the present disclosure as described above in any of its embodiments, which can then be cured to form an article of the present disclosure.

In some embodiments, the film in the article of the present disclosure has an adhesive [e.g., pressure sensitive adhesive (PSA)] disposed on a surface of the film. For example, in the schematic side view of the article of FIG. 4, reference number 50 may be an adhesive (e.g., PSA). In some embodiments, the article of the present disclosure includes a substrate having a first surface on which the film is disposed. In some embodiments, the first surface is a structured surface. In some embodiments, substrate has a second surface opposite the first surface, and the article further comprises an adhesive (e.g., PSA) disposed on the second surface of the substrate. Referring again to FIG. 1, PSA 350 is disposed on the second surface 332 of substrate 310.

The adhesive (e.g., PSA) allows the film or article to be adhered to surfaces. In some embodiments, the PSA provides good adhesion to surface, while also being removable under moderate force without leaving a residue on the surface. Examples of suitable materials for a PSA include one or more adhesives based on acrylates, urethanes, silicones, epoxies, rubber-based adhesives (including natural rubber, polyisoprene, polyisobutylene, and butyl rubber, block copolymers, and thermoplastic rubbers), and combinations thereof.

Examples of suitable acrylates include polymers of alkyl acrylate monomers such as methyl methacrylate, ethyl methacrylate, n-butyl methacrylate, methyl acrylate, ethyl acrylate, n-butyl acrylate, iso-octyl acrylate, iso-nonyl acrylate, 2-ethyl-hexyl acrylate, decyl acrylate, dodecyl acrylate, n-butyl acrylate, hexyl acrylate, and combinations thereof. Examples of commercially available block copolymers include those available under the trade designation “KRATON G-1657” from Kraton Polymers, Westhollow, TX.

An adhesive is considered to be “removable,” if after final application to an intended substrate, film can be removed without damage to the substrate at the end of the intended life of the article at a rate in excess of 7.62 meters/hour (25 feet/hour) by hand with the optional use of heat. In some embodiments, the removable PSA has a 180 degree peel strength (from a painted steel substrate employing a peel rate of 30.5 cm/min) of less than 8 N/cm, and more particularly less than 6 N/cm.

In some embodiments, the PSA useful in the article of the present disclosure is repositionable. “Repositionable” refers to the ability to be, at least initially, repeatedly adhered to and removed from a surface or substrate without substantial loss of adhesion capability. In some embodiments, the repositionable PSA has a peel strength, at least initially, to the substrate surface lower than that for a conventional aggressively tacky PSA.

Examples of suitable removable and repositionable pressure sensitive adhesives include those described in Hobbs et al., U.S. Publication No. 2005/0249791 and Cooprider et al., U.S. Pat. No. 5,571,617; and adhesives based on solid inherently tacky, elastomeric microspheres, such as those disclosed in Silver, U.S. Pat. No. 3,691,140, Merrill et al., U.S. Pat. No. 3,857,731, and Baker et al., U.S. Pat. No. 4,166,152. In some embodiments, the PSA includes an electrostatic charge. Permanent electrostatic charge can be imparted to the adhesive or the underlying film using corona charging (e.g., nitrogen or air), as described in Everaerts et al., U.S. Publication No. 2005/0000642. An electrostatic charge can be useful, for example, for removability of the PSA.

In some embodiments, the PSA exhibits sufficient optical quality and light stability such that the adhesive material does not yellow with time or upon weather exposure so as to degrade the viewing quality of the underlying surface. The adhesive material may be applied using a variety of known coating techniques such as transfer coating, knife coating, spin coating, and die coating. Additional examples of suitable adhesive materials for use in adhesive layer 350 include those described in Draheim et al., U.S. Publication No. 2003/0012936. Several of such adhesive materials are commercially available under the trade designations “8141”, “8142”, and “8161” adhesives from 3M Corporation, St. Paul, Minn.

The PSA may be substantially flat or comprise a topographical pattern. Topographical patterns are beneficial for bleeding air out from beneath the film, thereby reducing the amount of trapped air pockets beneath multi-layer film. Examples of suitable topographical patterns are discussed in Sher et al., U.S. Pat. No. 6,911,243.

The article of the present disclosure may also contain one or more tie layers to enhance adhesion of the film or the PSA to the substrate. Examples of suitable tie layer materials include extrudable polymers such as ethylene vinyl acetate polymers, modified ethylene vinyl acetate polymers (modified with acid, acrylate, maleic anhydride, individually or in combinations), and combinations thereof. The tie layer may also include blends of the above-discussed suitable tie layer materials with thermoplastic polymers. Tie layers for extrusion coating may also include materials such as polyethyleneimines, which are commonly used to enhance the adhesion of extrusion coated layers. Tie layers can be applied to a substrate by coextrusion, extrusion coating, laminating, or solvent coating processes. Examples of suitable layer thicknesses for the tie layers range from about 25 micrometers to about 100 micrometers.

The film disclosed herein may be provided to an end user in a variety of arrangements. For example, the film may be provided as a roll of tear-away film that allows consumers to remove desired amounts of film for individualized uses. Alternatively, film may be provided with pre-cut dimensions to fit industry standard components, such as touch-screen displays.

In some embodiments, the substrate in the article of the present disclosure comprises a thermoplastic or thermosettable material, in some embodiments, a thermoplastic. A method of making the article can include comprises thermoforming the substrate (e.g., film, sheet or plate) into an article. In some embodiments, vacuum forming may be used in combination with thermoforming, also known as dual vacuum thermoforming (DVT). In some embodiments, the thermoformed article may be a three-dimensional shell, such as an oxygen mask or (e.g. interior) automotive trim part.

The article of the present disclosure is typically not a (e.g., sterile) medical article such as nasal gastric tubes, wound contact layers, blood stream catheters, stents, pacemaker shells, heart valves, orthopedic implants (e.g., hips, knees, shoulders), periodontal implants (e.g., dentures, dental crowns), contact lenses, intraocular lenses, soft tissue implants (e.g., breast implants, penile implants, facial, and hand implants), surgical tools, sutures including degradable sutures, cochlear implants, tympanoplasty tubes, shunts including shunts for hydrocephalus, post-surgical drain tubes and drain devices, urinary catheters, endotraecheal tubes, heart valves, wound dressings, other implantable devices, and other indwelling devices. In some embodiments, the article is also not an orthodontic appliance or orthodontic brackets. These medical articles may be characterized as single use articles, i.e. the article is used once and then discarded. The above articles may also be characterized as single person (e.g., patient) articles. Thus, such articles are typically not cleaned (rather than sterilized) and reused with other patients.

In some embodiments, the articles of the present disclosure include those having a surface exposed to the surrounding (e.g. indoor or outdoor) environment and is subject to being touched or otherwise coming in contact with multiple people and/or animals, as well as other contaminants (e.g. dirt).

In some embodiments, a surface of the article, comes in direct (e.g. skin) contact with (e.g. multiple) people and/or animals during normal use of the article. In some embodiments, the surface may come in close proximity to (e.g. multiple) people/or animals in the absence of direct (e.g. skin) contact.

Such article surfaces can easily be contaminated with microorganisms (e.g. bacteria) and are therefore cleaned to prevent the spreading of microorganisms to others.

Representative articles that are amenable for use with a film disclosed herein or for integrating the film into the surface of the article include various interior or exterior surfaces or components of:
a) surface or component of a vehicle (e.g., automobile, bus, train, airplane, boat, ambulances, ships) as well as motorized and non-motorized shared vehicles such as car, scooters and bicycles including head rests, dashboards, door panels, window shutter (e.g. of an airplane), gear shifter, seat belt buckle, instrument and button panels, (e.g. plastic) seat back trays and arm rests, railings, cabin siding, luggage compartment, steering wheels, handlebars;
b) housing and cases of an electronic device (e.g., phone, laptop, tablet, or computer) as well as keyboards, mouses, mouse pads, and touchscreens, projectors, printers, remote control devices, locks, chargers (including cords and docking stations), fobs, video and arcade games, slot machines, automatic teller machines, scanners (e.g., handheld scanners), key cards, and point of sale electronic devices such as credit card readers, keypads, stylists, cash registers, barcode scanner, payment kiosks;
c) packaging film (e.g., for food or medical products) and polymeric shipping products including labels, mailers, boxes, totes, and bubble-wrap;
d) food preparation and dining surfaces, containers, and films including galleys, carts, cutting boards, lunch boxes, thermos, appliances (e.g., microwave, stove, ovens, blenders, toasters, coffee makers, refrigerator including shelves, beverage dispensers, and drawers), grills, utensils (e.g. especially handles thereof), plates, bowls, cups, water bottles, menus, condiments bottles, salt and pepper shakers, table tops and chairs (especially for public dining in restaurants, dorms, nursing homes, and prisons);
e) (e.g., non-sterile) surfaces of a medical, dental, or laboratory facility or medical, dental, or laboratory equipment (e.g. defibulators, ventilators and CPAPs (especially masks thereof), face shields, crutches, wheelchairs, bed rails, breast pump devices, IV pole and bags, curing lights (e.g. for dental materials), exam tables;
f) surfaces or components of furniture (e.g., desks, tables, chairs, seats, and armrests);
g) handles (e.g. knob, pull, levers including locks) of articles including furniture, doors of buildings (including push plates), turn styles, appliances, vehicles (e.g., interior and exterior door handles and transportation hand holds), shopping carts and baskets, exercise equipment, (e.g. cooking) utensils, tools, handlebars, levers of window blinds, microphone, luggage, etc.;
h) building surfaces (including escalators and elevators) such as doors, railings, walls, flooring, countertops, desktops, cabinets, lockers, windows (e.g., sills), doorbells, electrical modulators (e.g. light switches, dimmers, and outlets including plates thereof);
i) surfaces and components of lavatories (e.g. sink, toilet surfaces (e.g. levers), drain caps, shower walls, bathtub, vanity, countertop);
j) surface or liner of a swimming pool or roofing material;
k) personal items including toothbrushes eye glass frames, shoes, clothing, helmets, head bands, hard hats, headphones, footwear (e.g. shoes and boots), handbags, and backpacks;
l) articles for children including toys, pacifiers, bottles, teethers, car seats, cribs, changing tables, and playground equipment;
m) cleaning equipment (e.g. vacuum, mop, scrub brush, dusters, toilet bowl cleaners, plunger, brooms), garbage and recyclable containers;
n) protective athletic and sports equipment (e.g. helmets, guards, balls for various sports including football, basketball, soccer, and golf);
o) exercise, spa, and salon (e.g. hair styling and nail) equipment (e.g. weights, yoga mats);
p) office and schools supplies and equipment including writing instruments (e.g. pencils, pens, markers), writable surfaces (including films and white boards), erasers, file folders, book and notebook covers, scanner and copy machines; and
q) manufacturing surfaces and equipment including conveyor belts, control panels for machine operation (e.g. of an assembly line).

The article of the present disclosure is particularly advantageous for congregate living facilities such as military housing, prisons, dorms, nursing homes, apartments, hotels; public places such as offices, schools, arenas, casinos, bowling alleys, golf courses, arcades, gyms, salons, spas, shopping centers, airports, train stations; and public transportation.

In some embodiments, the film for application to vehicle, building, or other surface may be characterized as an architectural, decorative, or graphic film. Graphic films typically include patterns, images, or other visual indicia. The graphic film may be a printed film, or the graphic may be created by means other than printing.

In some embodiments, the article comprising the film of the present disclosure further comprises an interior or exterior surface of a vehicle, a housing or case of an electronic device, or a furniture component.

In use in an article of the present disclosure, the film described herein provides both physical and antimicrobial protection to the article. The antimicrobial pendent groups represented by formula —C(O)—O-Q-N⁺(R)2CnH2n+1(X—) in which R, n, and X— are as described above in any of their embodiments can reduce pathogenic contamination of the surface. Examples of suitable levels of antimicrobial activity include microbial load reductions of at least about 90% for at least one of S. aureus (gram positive) and Ps. aeruginosa (gram negative) pathogens. Further examples of suitable levels of antimicrobial activity include microbial load reductions of at least about 99% for at least one of S. aureus (gram positive) or Ps. aeruginosa (gram negative) pathogens. Further examples of suitable levels of antimicrobial activity include microbial load reductions of at least about 90% for both of S. aureus (gram positive) and Ps. aeruginosa (gram negative) pathogens. Further examples of even more particularly suitable levels of antimicrobial activity include microbial load reductions of at least about 99% for both of S. aureus (gram positive) and Ps. aeruginosa (gram negative) pathogens. The “microbial load reductions” herein refer to microbial load reductions obtained pursuant to ASTM E2180-01. See, for example, Examples 14 to 17 and 24 to 26 in the Examples, below, which show that the film of the present disclosure can cause a reduction in microbial load.

The film of the present disclosure may be mechanically cleaned, for example by wiping the film surface with a woven or non-woven material or scrubbing the film surface with a brush. Solvents and/or aqueous cleaners may be useful for cleaning the film surface. Since a film includes a plurality of pendent groups represented by formula —C(O)—O-Q-N⁺(R)₂CₙH₂ₙ₊₁(X—) covalently bonded in a crosslinked acrylic network, the film can be durable to such cleaning methods without being removed from a surface of a substrate, for example. See, for example, Examples 5 to 10 and 18 to 23 in the Examples, below, which show that the film of the present disclosure is not removed from a substrate when rubbed with a paper towel.

### Some Embodiments of the Present Disclosure

In a first embodiment, the present disclosure provides a composition comprising:
an antimicrobial monomer represented by formula CH₂═C(R¹)—C(O)—O-Q-N⁺(R)₂CₙH₂ₙ₊₁(X—), wherein R¹ is hydrogen or methyl, Q is alkylene having up to six carbon atoms, each R is independently alkyl having up to four carbon atoms, n is an integer from 1 to 22, and X— is an anion;
a non-fluorinated crosslinking monomer having at least two acrylate groups, methacrylate groups, or a combination thereof, wherein the crosslinker is present in an amount of greater than 30 percent by weight, based on the total weight of the composition;
a polar monomer comprising at least one of acrylic acid, methacrylic acid, or a carboxylate salt thereof, wherein the polar monomer is present in an amount from 0 percent to 50 percent by weight, based on the total weight of the composition; and
a nonpolar monomer represented by formula CH₂═C(R¹)—C(O)—O—R² in an amount from 0 percent to 50 percent by weight, based on the total weight of the composition, wherein R¹ is hydrogen or methyl and R² is alkyl having from four to 18 carbon atoms;
   wherein the antimicrobial monomer, the non-fluorinated crosslinking monomer, the polar monomer, and the nonpolar monomer together account for greater than 95, 96, 97, or 98 percent by weight, based on the total weight of the composition.

In a second embodiment, the present disclosure provides the composition of the first embodiment, wherein n is an integer from 12 to 16.

In a third embodiment, the present disclosure provides the composition of the first or second embodiment, wherein the non-fluorinated crosslinking monomer has at least three acrylate groups, methacrylate groups, or a combination thereof.

In a fourth embodiment, the present disclosure provides the composition of any one of the first to third embodiments, wherein X— is a halide anion (e.g., chloride, bromide, fluoride, or iodide) BF₄, N(SO₂CF₃)₂, O₃SCF₃, O₃SC₄F₉, O₄SCH₃, or hydroxide.

In a fifth embodiment, the present disclosure provides the composition of any one of the first to fourth embodiments, wherein the composition is free of silica particles or comprises not more than four percent by weight silica particles, based on the total weight of the composition.

In a sixth embodiment, the present disclosure provides the composition of any one of the first to fifth embodiments, wherein the non-fluorinated crosslinking monomer is present in an amount of at least 35 percent by weight, based on the total weight of the composition.

In a seventh embodiment, the present disclosure provides the composition of any one of the first to sixth embodiments, wherein the polar monomer is present in an amount of at least 25 percent by weight, based on the total weight of the composition.

In an eighth embodiment, the present disclosure provides the composition of any one of the first to seventh embodiments, wherein the nonpolar monomer is present in an amount of 0 percent by weight to 49 percent by weight or 0 percent by weight, based on the total weight of the composition.

In a ninth embodiment, the present disclosure provides the composition of any one of the first to eighth embodiments, wherein the antimicrobial monomer is present in an amount in a range from two percent by weight to 50 percent by weight, based on the total weight of the composition.

In a tenth embodiment, the present disclosure provides an article comprising a film comprising a plurality of pendent groups represented by formula —C(O)—O-Q-N⁺(R)₂CₙH₂ₙ₊₁(X—) covalently bonded in a crosslinked acrylic network, wherein Q is alkylene having up to six carbon atoms, each R is independently alkyl having up to four carbon atoms, n is an integer from 1 to 22, and X— is an anion, and wherein the crosslinked acrylic network is derived from the composition of any one of the first to ninth embodiments.

In an eleventh embodiment, the present disclosure provides the article of the tenth embodiment, wherein the film has a surface comprising microstructures, nanostructures, or combinations thereof.

In a twelfth embodiment, the present disclosure provides an article comprising a film having a surface comprising microstructures, nanostructures, or combinations thereof, the film comprising a plurality of pendent groups represented by formula —C(O)—O-Q-N⁺(R)₂ CₙH₂ₙ₊₁(X—) covalently bonded in a crosslinked non-fluorinated acrylic network, wherein Q is alkylene having up to six carbon atoms, each R is independently alkyl having up to four carbon atoms, n is an integer from 1 to 22, and X— is an anion.

In a thirteenth embodiment, the present disclosure provides the article of the twelfth embodiment, wherein the crosslinked non-fluorinated acrylic network is derived from a composition comprising:
an antimicrobial monomer represented by formula CH₂═C(R¹)—C(O)—O-Q-N⁺(R)₂CₙH₂ₙ₊₁(X—), wherein R¹ is hydrogen or methyl, Q is alkylene having up to six carbon atoms, each R is independently alkyl having up to four carbon atoms, n is an integer from 1 to 22, and X— is an anion;
a non-fluorinated crosslinking monomer having at least two acrylate groups, methacrylate groups, or a combination thereof, wherein the crosslinker is present in an amount of greater than 25 percent or at least 30 or 35 percent by weight, based on the total weight of the composition;
a polar monomer comprising at least one of acrylic acid, methacrylic acid, or a carboxylate salt thereof, wherein the polar monomer is present in an amount from 0 percent to 50 percent by weight, or in an amount of at least 25 percent by weight based on the total weight of the composition; and
a nonpolar monomer represented by formula CH₂═C(R¹)—C(O)—O—R² in an amount from 0 percent to 50 percent by weight, or 0 percent to 49 percent by weight, based on the total weight of the composition, wherein R¹ is hydrogen or methyl and R² is alkyl having from four to 18 carbon atoms.

In a fourteenth embodiment, the present disclosure provides the article of any one of the eleventh to thirteenth embodiments, wherein the microstructures, nanostructures, or combinations thereof comprise at least one of continuous peaks and adjacent valleys, pyramids, cones, hemispherical bumps, upstanding posts, or cube corners.

In a fifteenth embodiment, the present disclosure provides the article of any one of the eleventh to fourteenth embodiments, wherein the microstructures, nanostructures, or combinations thereof have a complement cumulative slope magnitude distribution such that at least 30 percent have a slope magnitude of at least 0.7 degrees, and at least 25 percent have a slope magnitude of less than 1.3 degrees.

In a sixteenth embodiment, the present disclosure provides the article of any one of the eleventh to fifteenth embodiments, wherein the microstructures, nanostructures, or combinations thereof have geometrical symmetry and asymmetric slope distribution, wherein no more than about 7% of the structured major surface has a slope magnitude greater than about 3.5 degrees or no more than about 4% of the structured major surface has a slope magnitude greater than about 5 degrees or wherein the microstructures, nanostructures, or combinations thereof have geometrical asymmetry and symmetric slope distribution, wherein no more than about 7% of the structured major surface has a slope magnitude greater than about 3.5 degrees or no more than about 4% of the structured major surface has a slope magnitude greater than about 5 degrees.

In a seventeenth embodiment, the present disclosure provides the article of any one of the tenth to sixteenth embodiments, wherein the nanostructures are on the microstructures.

In an eighteenth embodiment, the present disclosure provides the article of any one of the tenth to seventeenth embodiments, further comprising a substrate having a first structured surface, wherein the first structured surface comprises the microstructures, nanostructures, or combinations thereof, wherein the film is disposed on the first structured surface.

In a nineteenth embodiment, the present disclosure provides the article of the eighteenth embodiment, wherein substrate comprises a fluoropolymer film.

In a twentieth embodiment, the present disclosure provides the article of the eighteenth or nineteenth embodiment, wherein the microstructures cover not more than about 95%, 90%, 85%, 80%, 75%, 70%, 65%, 60%, 55%, or 50% of the first structured surface.

In a twenty-first embodiment, the present disclosure provides the article of any one of the eighteenth to twentieth embodiments, wherein substrate has a second surface opposite the first structured surface, and wherein the article further comprises a pressure sensitive adhesive disposed on the second surface of the substrate.

In a twenty-second embodiment, the present disclosure provides the article of any one of the tenth to twenty-first embodiments, further comprising a pressure sensitive adhesive disposed on a surface of the film.

In a twenty-third embodiment, the present disclosure provides the article of any one of the tenth to twenty-second embodiments, wherein the article further comprises an interior or exterior surface of a vehicle, a housing or case of an electronic device, or a furniture component.

In a twenty-fourth embodiment, the present disclosure provides a process of making an article, the process comprising:
combining the composition of any one of the first to ninth embodiments with a photoinitiator,
coating the resulting composition onto a substrate; and
exposing the composition to actinic radiation to form a film.

In a twenty-fifth embodiment, the present disclosure provides the process of the twenty-fourth embodiment, wherein the substrate has a first structured surface, wherein the first structured surface comprises microstructures, nanostructures, or combinations thereof, and wherein the composition is coated on the first structured surface.

In a twenty-sixth embodiment, the present disclosure provides the process of the twenty-fourth embodiment, wherein the substrate comprises a tool having a negative replication of a surface comprising microstructures, nanostructures, or combinations thereof, the process further comprises removing the film from the tool.

In a twenty-seventh embodiment, the present disclosure provides the process of the twenty-fifth or twenty-sixth embodiments, wherein the microstructures, nanostructures, or combinations thereof comprise at least one of continuous peaks and adjacent valleys, pyramids, cones, hemispherical bumps, upstanding posts, or cube corners.

In a twenty-eighth embodiment, the present disclosure provides the process of any one of the twenty-fifth to twenty-seventh embodiments, wherein the microstructures, nanostructures, or combinations thereof have a complement cumulative slope magnitude distribution such that at least 30 percent have a slope magnitude of at least 0.7 degrees, and at least 25 percent have a slope magnitude of less than 1.3 degrees.

In a twenty-ninth embodiment, the present disclosure provides the process of any one of the twenty-fifth to twenty-eighth embodiments, wherein the microstructures, nanostructures, or combinations thereof have geometrical symmetry and asymmetric slope distribution, wherein no more than about 7% of the structured major surface has a slope magnitude greater than about 3.5 degrees or no more than about 4% of the structured major surface has a slope magnitude greater than about 5 degrees or wherein the microstructures, nanostructures, or combinations thereof have geometrical asymmetry and symmetric slope distribution, wherein no more than about 7% of the structured major surface has a slope magnitude greater than about 3.5 degrees or no more than about 4% of the structured major surface has a slope magnitude greater than about 5 degrees.

In a thirtieth embodiment, the present disclosure provides the process of any one of the twenty-fifth to twenty-ninth embodiments, wherein the microstructures cover not more than about 95%, 90%, 85%, 80%, 75%, 70%, 65%, 60%, 55%, or 50% of a surface of the substrate.

In a thirty-first embodiment, the present disclosure provides the process of any one of the twenty-fifth to thirtieth embodiments, wherein the substrate is a fluoropolymer film.

In a thirty-second embodiment, the present disclosure provides the process of any one of the twenty-fifth to thirty-first embodiments, wherein the nanostructures are on the microstructures.

In a thirty-third embodiment, the present disclosure provides the process of any one of the twenty-fourth to thirty-second embodiments, further comprising adhering the film or the substrate to a surface.

In a thirty-fourth embodiment, the present disclosure provides the process of the thirty-third embodiment, wherein the surface comprises an interior or exterior surface of a vehicle, a housing or case of an electronic device, or a furniture component.

In a thirty-fifth embodiment, the present disclosure provides the process of any one of the twenty-fourth to thirty-fourth embodiments, further comprising thermoforming at least one of the article or the substrate.

### EXAMPLES

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

TABLE 1
Materials

| Designation | Description | Source |
|---|---|---|
| AA | Acrylic acid | BASF Corporation, Florham |
| | | Park, NJ, United States |
| ARCM | (Acryloyloxyethyl)-N,N,N- | See Preparatory Example 3 |
| | trimethylammonium | |
| | bis(trifluoromethanesulfonyl)imide | |
| BHT | 2,6-Di-tert-4-methyl phenol | Sigma Aldrich, Milwaukee, WI. |
| | | United States |
| C₁₆H₃₃Br | 1-bromohexadecane | Chemtura Corporation, Bay |
| | | Minette, AL. United States |
| C₆H1₃Br | 1-bromohexane | Chemtura Corporation |
| DMAEA | Dimethylaminoethyl methacrylate | BASF Corporation |
| DMAEA-C₆Br | Dimethylaminoethyl methacrylate C6 | See Preparatory Example 2 |
| | bromide | |
| DMAEA-C₁₆Br | Dimethylaminoethyl methacrylate C16 | See Preparatory Example 1 |
| | bromide | |
| DMAEA-MCl | Acryloxythyltrimethyl ammonium chloride | Solenis, Wilmington, DE, |
| | available under the trade designation | United States |
| | “AGEFLEX FA1Q80MC” | |
| Esacure ONE | A difunctional alpha hydroxyketone | IGM Resins, St. Charles, IL. |
| | photoinitiator available under the designation | United States |
| | Esacure ONE | |
| EtOAc | Ethyl acetate | J. T. Baker, Austin, TX. United |
| | | States |
| HQ-115 | Lithium bis-trifluoromethane sulfonimide | 3M Company, St. Paul, MN. |
| | available under the designation HQ-115 | United States |
| Irgacure 819 | An acyl phosphine oxide photoinitiator | Millipore Sigma, St. Louis, |
| | available under the designation Irgacure 819 | MO, United States |
| LUCIRIN TPO | 2,4,6-Trimethylbenzoyldiphenylphosphine | BASF Corporation |
| | oxide. A photoinitiator available under the | |
| | designation Lucirin ® TPO | |
| M3150 | Trimethylolpropane(EO)15 triacrylate | Miwon Speciality Chemical Co. |
| | available under the designation Miramer | Ltd, Yongin-si Gyeonggi-do, |
| | M3150 | Korea |
| MEHQ | 4-methoxyphenol | Alfa Aesar, Ward Hill, MA. |
| | | United States |
| PHOTOMER 6210 | Aliphatic urethane diacrylate oligomer | IGM Resins, Charlotte, NC, |
| | available under the designation Photomer ® | United States |
| | 6210 | |
| SR238 | 1,6-hexanediol diacrylate available under the | Sartomer, Chatham, VA. |
| | designation SR238 | United States |
| SR9035 | Ethoxylated, trimethylopropane triacrylate | Sartomer |
| | available under the designation SR9035 | |

### Test Methods

### Adhesion:

ASTM D 3359-17 Test Method B was followed. Adhesion was assessed on a 0 to 5 scale. A 0 represented that greater than 6500 area was removed and a 5 represented that 0% area was removed.

### Rub Test:

A paper towel was soaked with either isopropyl alcohol or water and rubbed by hand on the surface of a sample for 20 strokes. Visual observations were recorded.

### Microbial Touch Transference Method:

Bacterial Inoculum Preparation: Tryptic Soy Agar was prepared per the manufacturer's instructions on the bottle. A streak plate of Staphylococcus aureus (ATCC® 6538) was prepared from a frozen stock on Tryptic Soy Agar and left at 37° C. overnight to incubate. Two colonies from the plate were used to inoculate 9 mL of sterile Butterfield's Buffer (flip top tube). The optical density (absorbance) was read at 600 nm, to confirm that the reading was 0.040±0.010, it was adjusted as necessary to fall in this range, and then 1.5 mL of the culture was added to 45 mL of Butterfield's Buffer in a sterile 50-mL conical tube to make the inoculation solution for the touch transfer experiment. Each inoculation solution was enumerated using Butterfield's Buffer and serial dilutions were plated on 3M Aerobic Count Petrifilm to confirm the cell concentration for each experiment.

Sample Preparation: Adapted from WK67781 working group standard from ASTM (attached as supporting information). Individual film samples were cut to 50±2×50±2 mm squares of control and microstructured test films and adhered to the bottom of a sterile 100-mm Petri dish using a small piece of 3M double sided tape. Each sample was wiped three times using a KimWipe wet with 95% isopropyl alcohol. Samples were dried under the fan in a BioSafety Cabinet for 15 minutes then sterilized by irradiation of the apical surface using the BioSafety Cabinet's UV light for 30 minutes.

Inoculation of Samples: Twenty-five mL of the inoculation solution was poured into a sterile 100-mm Petri dish. For each sample, an autoclave-sterilized 42.5 mm circle of Whatman Filter Paper (Grade 2) was immersed in the Petri dish containing the inoculation solution for 5 seconds using flame-sterilized tweezers. The carrier was removed and held over the Petri dish for 25 seconds for excess inoculum to drain. The inoculated paper was placed on top of the film sample and an autoclave-sterilized piece of Whatman Filter paper (Grade 2, originally 90-mm circle cut to a 60×60 mm square prior to autoclave sterilization) was placed on top of the inoculated sample. A sterile cell spreader was pressed on top of the sample and moved across the surface twice in perpendicular directions. The sample was left to sit for two minutes with both pieces of filter paper on top of the film. After the two-minute exposure, both pieces of filter paper were removed with sterile tweezers and discarded in a biohazardous waste container and the sample was allowed to air dry at room temperature for 5 minutes. Touch transfer of the inoculated bacteria was assessed by pressing a RODAC plate evenly onto the sample (microstructured or smooth control) for 5 seconds using uniform pressure (˜300 g). The RODAC plates were incubated at 37° C. overnight (18-24 h) and the number of colony forming units (CFU) were counted and recorded the following morning. Each microstructured sample and smooth control samples were performed in triplicate.

Data Analysis: The log 10 reduction in touch transfer was calculated by performing a log 10 transformation on the number of CFU per RODAC plate, then calculating the log 10 reduction by subtracting the log 10 value from the microstructured sample from the log 10 value from the corresponding smooth film control. The % reduction was then calculated on from the average log 10 reduction from the following equation: % Reduction=(1−10(−log 10 reduction value))*100

### Antimicrobial Activity and Efficacy

The methods of JIS Z2801 were followed. Media Preparation: Tryptic soy broth (TSB) was prepared as directed on the manufacturer's label by dissolving 37 g/L in deionized water and filter sterilizing the solution.

Bacterial Culture: Tryptic Soy Agar was prepared per the manufacturer's instructions on the bottle. A streak plate of Staphylococcus aureus (ATCC® 6538) was prepared from a frozen stock on Tryptic Soy Agar and left at 37° C. overnight to incubate. An overnight culture of Staphylococcus aureus (ATCC® 6548) or Pseudomonas aeruginosa (ATCC® 15442) was grown by selecting a single colony and inoculating a tube with 10 mL of TSB then incubated at 37° C. while shaking at 250 rpm for 12-16 hours. Two 1-mL aliquots of the overnight culture were centrifuged at 5000×g for 5 minutes to pellet the cells, the supernatant was removed from each and the bacteria in each tube were resuspended in 1 mL of phosphate buffered saline (PBS; pH 7.4). The 1 mL of PBS containing S. aureus or P. aeruginosa from one tube was then transferred to a 15-mL conical vial and diluted with PBS to a final volume of 10 mL. The resulting solution was used as the PBS inoculum.

Sample Preparation: A 20-mm diameter circular hollow punch was used to cut out individual discs. The discs were removed from the punch and transferred to a sterile 6-well plate. Two discs were placed in each well.

Sample Inoculation and Incubation: Samples were inoculated by pipetting 100 uL of the corresponding inoculation solution (in PBS) onto one of the 20 mm discs in each well. The second disc in each well was then placed on top of the inoculum on the first disc, sandwiching the inoculum between the two film samples. After inoculation, half of the 6-well plates were placed inside a Ziploc bag containing a paper towel saturated with water and moved to 37° C. for a 24 hour static incubation. The other half of the samples were harvested immediately for quantitative recovery at the 0 h time point. All samples were prepared in triplicate.

Sample recovery: Each sample was transferred to an individual 50-mL conical vial containing 10 mL of PBS buffer containing 0.05% Tween 20. Each tube was vortexed for one minute, then sonicated for one minute using a Branson Ultrasonic Cleaner, then vortexed for one minute. After the second vortexing step, each tube was serially diluted in Butterfield's buffer to the −8 dilution (the original tube served as the −1 dilution) and 1 mL from each dilution was plated on 3M Aerobic Count PetriFilm. The PetriFilm was incubated at 37° C. for 24 hours. The number of colony forming units (CFU) on each plate were counted after the 24 hour incubation using a 3M PetriFilm reader.

### Preparatory Example 1

546 parts of acetone, 488 parts of C₁₆H₃₃Br, 225 parts of DMAEA, 1.0 parts of BHT and 1.0 parts of MEHQ were placed in a clean reactor fitted with an over-head condenser, a mechanical stirrer, and a temperature probe. The batch was stirred at 150 RPM and 90/10 ratio of O₂/N₂ was purged through the solution throughout the reaction scheme. The mixture was heated to 74° C. for 18 hours. A sample was removed for analysis by gas chromatography and a conversion of greater than 98% resulted. At this point, the heating of the reaction mixture was stopped and 1,000 parts of EtOAc was added slowly and stirred at very high speed. A white solid precipitated out. The mixture was cooled to ambient temperature. The reaction mixture was filtered, and a white solid monomer was washed with 1,000 parts of cold EtOAc. The white solid monomer was transferred to a tray and dried in a vacuum oven at 40° C. for eight hours. A DMAEA-C16Br monomer was produced.

### Preparatory Example 2

A DMAEA-C6Br monomer was produced by following the same procedure described in Preparatory Example 1 except using C₆H₁₃Br instead of C₁₆H₃₃Br.

### Preparatory Example 3

1486 grams (79.1% solids in water, 6.069 mol) of DMAEA-MCl was added to a tared 5 L, 3-necked round-bottom flask equipped with overhead stirrer and the contents were heated to 40° C. To the flask was added, over about one minute, 2177.33 grams (80% solids in water, 6.069 mol) HQ-115, followed by 597.6 grams deionized water. After stirring for one hour, the reaction was transferred to a separatory funnel and the lower organic layer (2688.7 grams) was returned to the reaction flask and washed with 1486 grams of deionized water at 40° C. for 30 minutes. The lower layer (2656.5 g) was again separated from the aqueous layer and place in a dry 5 L, 3-necked round-bottom flask equipped with overhead stirrer, stillhead, and air bubbler. To the flask was added 2000 g acetone and the reaction was distilled at atmospheric pressure over six hours with an air sparge to azeotropically dry the product with a yield of 2591 grams of a clear liquid, which slowly crystallizes to a. NMR analysis revealed greater than 99.9%, ARCM formation.

### Preparatory Example 4

A UV curable resin was prepared from PHOTOMER 6210 (75 parts), SR238 (25 parts), and LUCIRIN TPO photoinitiator (0.5%). The components were blended in a high-speed mixer, heated in an oven at about 70° C. for 24 hours) and then cooled to room temperature. Approximately six drops of the resin were applied using a transfer pipette to a first MELINEX 618 PET support film [3 inch by 4 inch (7.62 cm by 10.16 cm), 0.127 mm thick] obtained from DUPONT TEIJIN FILMS of Chester, VA, United States. The primed surface of the PET film was oriented to contact the resin creating a resin/PET stack. A glass plate was placed on the unprimed surface of the first PET film on the opposite side to where the resin was placed. A second MELINEX 618 PET support film [3 inch by 4 inch (7.62 cm by 10.16 cm), 5 mil thick] was placed on top of resin/PET stack with the unprimed side contacting the resin. The entire assembly was laminated by a rubber roller laminator to spread and flatten resin and photo cured with a stand-alone UV curing system. The second PET film was peeled away, and the glass plate was carefully removed.

### Preparatory Example 5

A skipped tooth riblet (STR) reactive ion etched polyvinylidene fluoride (STR-RIE PVDF) film with micro-structured linear prisms spaced apart with flat lanes separating the linear prisms was made as follows. An extrusion replication casting roll having a riblet prismatic surface was created by a diamond turning machine (DTM) method. PVDF polymer (“3M DYNEON PVDF 6008”) was extruded onto the extrusion replication casting roll having the riblet prismatic surface. The PVDF polymer was extruded onto the extrusion replication casting roll having a surface temperature of 82.2° C. (180° F.) at an extrusion rate of 40.8 kg./hr. (90 lb./hr.) and a casting roll speed of 12.2 meters per minute (40 fpm). A nip force of 4136.9 kPa (600 psi) was applied to the polymer as it contacted the extrusion replication casting roll to produce the STR PVDF film. The STR PVDF film then exposed to a nano-structure-generating reactive ion etching (RIE) treatment to form a columnar nanostructure on the micro-structured prisms and flat lanes, thereby producing a STR-RIE PVDF film, and a cross-sectional view of the resulting surface is shown in FIG. 5. The RIE process was as follows. The masking element used had a size in the range of 1 nanometer to 500 nanometers and was deposited in-situ with the reactive ion etching process treatment as described in U.S. Pat. Pub. 2017/0067150 (David et al.). For each film, a roll of film was mounted within a plasma vapor deposition reacting chamber, the film wrapped around a drum electrode, and secured to the take up roll on the opposite side of the drum. The un-wind and take-up tensions were maintained at 3 pounds (13.3 N). The chamber door was closed, and the chamber pumped down to a base pressure of 5×10⁻⁴ Torr. A first gaseous species of hexamethyldisiloxane (HMDSO) vapor was provided at 50 standard cubic centimeters per minute (sccm), and a second gaseous species of oxygen was provided at a flow rate of 750 sccm. The pressure during the exposure was around 1.3 Pa (10 mTorr). Plasma power was maintained at 7500 watts, and line speed of the film was 0.9 meters per minute (3 feet/min).

### Examples 1-4 (EX1-EX4)

In a reaction flask, 40 parts of ARCM and 60 parts SR9035 were mixed by using a mechanical stirrer for one hour. Then, a designated photo-initiator (as identified in Table 2) was added and mixed for two hours. The coating formulations were coated on a Melinex® PET film (obtained from DUPONT TEIJIN FILMS) and ultraviolet light cured either creating a flat or micro-replicated surface structure. A process as described in PCT Pub No. WO 2011/071689 A1 (Tse et al.), page 11, lines 11-15 created the flat film. A multi-tipped diamond tool was used to create a micro-replicated surface, and the process described in Example 1 of US Pat Pub. No. 2013/0236697 (Walker et al) was used to create the film having a combination of microstructures and nanostructures on one surface. Visual observations were noted and are also represented in Table 2.

TABLE 2
Compositions and Visual Observations

| | ARCM:SR9035 | Irgacure 819 | Esacure ONE | Coating Surface | Visual |
|---|---|---|---|---|---|
| Example | (grams) | (grams) | (grams) | Structure | Observation |
| EX1 | 50 | 0.05 | 0 | Flat | Clear |
| EX2 | 50 | 0 | 0.15 | Flat | Clear |
| EX3 | 50 | 0.05 | 0 | Micro-replicated | Hazy |
| EX4 | 50 | 0 | 0.15 | Micro-replicated | Hazy |

### Examples 5-8 (EX5-EX8)

In a reaction flask, 40 parts of ARCM and 60 parts SR9035 were mixed by using a mechanical stirrer for one hour. Then, a designated photo-initiator (as identified in Table 3) was added and mixed for two hours. The coating formulations were coated on a Melinex® PET film and ultraviolet light cured either creating a flat or micro-replicated surface structure. A process as described in PCT Pub No. WO 2011/071689 A1 (Tse et al.), page 11, lines 11-15 created the flat film. A multi-tipped diamond tool was used to create a micro-replicated tool surface, and the process described in Example 1 of US Pat Pub. No. 2013/0236697 (Walker et al) was used to create the film having a combination of microstructures and nanostructures on one surface. Adhesion and Rub Testing were conducted as well as visual observations were noted and are represented in Table 3.

TABLE 3
Compositions and Visual Observations

| | | Irgacure | Esacure | | Adhesion | | |
|---|---|---|---|---|---|---|---|
| | ARCM:SR9035 | 819 | ONE | Coating | Test | Rub | Visual |
| Example | (grams) | (grams) | (grams) | Surface Structure | Results | Test Results | Observation |
| EX5 | 50 | 0.05 | 0 | Flat | 5 | None removed | Clear |
| EX6 | 50 | 0 | 0.05 | Flat | 5 | None removed | Clear |
| EX7 | 50 | 0.05 | 0 | Micro-replicated | 5 | None removed | Hazy |
| EX8 | 50 | 0 | 0.05 | Micro-replicated | 5 | None removed | Hazy |

### Examples 9-10 (EX9-EX10)

In a reaction flask, either a one-to-one ratio of DMAEA-C16Br:AA or DMAEA-C6Br:AA was added. Refer to Table 4 for further material quantities. The mixture was heated to 40° C. and stirred for five minutes producing a clear solution. The mixture was cooled to room temperature and ARCM:SR-9035 (40:60 ratio) was added and mixed for 30 minutes. Then, Esacure One was added and mixed for 60 minutes. The coating formulations were coated on a Melinex® PET film and ultraviolet light cured, creating a flat surface. A process as described in PCT Pub No. WO 2011/071689 A1 (Tse et al.), page 11, lines 11-15 created the flat film. Adhesion and Rub Testing were conducted as well as visual observations were noted and are represented in Table 4.

TABLE 4
Compositions and Visual Observations

| | | DMAEA- | DMAEA- | Esacure | Coating | Adhesion | | |
|---|---|---|---|---|---|---|---|---|
| | ARCM:SR9035 | C16Br:AA | C6Br:AA | ONE | Surface | Test | Rub | Visual |
| Example | (grams) | (grams) | (grams) | (grams) | Structure | Results | Test Results | Observation |
| EX9 | 20 | 2.6 | 0 | 0.16 | Flat | 5 | None removed | Clear |
| EX10 | 20 | 0 | 2.4 | 0.12 | Flat | 4 | None removed | Clear |

### Example 11 (EX11)

Quantities of the materials identified in Table 5 were mixed by using a mechanical stirrer. DMAEA-C16Br and AA were mixed in a flask and stirred for 30 minutes producing a clear solution. M3150 was added, and the mixture was stirred for 15 minutes. Then, Esacure ONE was added and mixed for two hours or until a clear solution was produced. The coating formulation was coated on a primed Melinex® PET film and ultraviolet cured creating a micro-replicated surface structure. A multi-tipped diamond tool was used to create a micro-replicated tool surface, and the process described in Example 1 of US Pat Pub. No. 2013/0236697 (Walker et al) was used to create the film having a combination of microstructures and nanostructures on one surface.

### Example 12 (EX12)

Quantities of the materials identified in Table 5 were mixed by using a mechanical stirrer. DMAEA-C16Br and AA were mixed in a flask and stirred for 30 minutes producing a clear solution. SR9035 was added, and the mixture was stirred for 15 minutes. Then, Esacure ONE was added and mixed for two hours or until a clear solution was produced. The coating formulation was coated on a STR-RIE PVDF film assembled as described in Preparatory Example 5 and cured using ultraviolet light.

### Example 13 (EX13)

A coating formulation was created as described in EX12. The coating formulation was coated on a flat film as assembled in Preparatory Example 4 and cured using ultraviolet light.

TABLE 5
Composition

| | | | Esacure | | |
|---|---|---|---|---|---|
| | AA | DMAEA-C16Br | ONE | M3150 | SR9035 |
| Example | (grams) | (grams) | (grams) | (grams) | (grams) |
| EX11 | 8.0 | 8.0 | 0.084 | 12.0 | 0.0 |
| EX12 | 8.0 | 8.0 | 0.084 | 0.0 | 12.0 |

### Examples 14-17 (EX14 and EX17)

Antimicrobial efficacy testing was performed on samples assembled as described in EX9 (#1), EX10 (#2), EX12 (#3), and EX13 (#4). The control was the Melinex® PET flat film without a coating applied. Results are represented in Table 6.

TABLE 6
Antimicrobial Performance

| | | Time = | | Time = | | Log | % | |
|---|---|---|---|---|---|---|---|---|
| Example | Sample | 0 hours | Error | 24 hours | Error | Reduction | Reduction | Microorganism |
| EX14 | #1 | N/A | N/A | 0.49 | 0.00 | 5.92 | 99.999 | S. aureus |
| EX15 | #2 | N/A | N/A | 1.38 | 0.04^{a} | 5.03 | 99.999 | S. aureus |
| EX16 | #3 | 8.69 | 0.06^{b} | 0.0 | 0.0^{b} | 8.69 | 99.999999 | P. aeruginosa |
| EX17 | #4 | 8.86 | 0.12^{b} | 1.18 | 2.05^{b} | 7.68 | 99.99999 | P. aeruginosa |
| Control | None | 6.40 | 0.0 | 6.41 | 0.05 | N/A | N/A | N/A |

^{a}Standard Error,
^{b}Standard Deviation

### Examples 18-23 (EX18-EX23)

In a reaction flask, material quantities as represented in Table 7 were added. DMAEA-C16Br or DMAEA-C6Br was added with AA and the mixture was heated to 40° C. and stirred for five minutes producing a clear solution. The mixture was cooled to room temperature and ARCM:SR-9035 (40:60 ratio) was added and mixed for 30 minutes. Then, Esacure One was added and mixed for 60 minutes. The coating formulations were coated on a Melinex® PET film and ultraviolet cured either creating a flat or micro-replicated surface structure. A process as described in PCT Pub No. WO 2011/071689 A1 (Tse et al.), page 11, lines 11-15 created the flat film. A multi-tipped diamond tool was used to create a micro-replicated tool surface, and the process described in Example 1 of US Pat Pub. No. 2013/0236697 (Walker et al) was used to create the film having a combination of microstructures and nanostructures on one surface. Adhesion and Rub Testing were conducted as well as visual observations were noted and are represented in Table 8.

TABLE 7
Coating Compositions

| | | DMAEA- | DMAEA- | | | Esacure |
|---|---|---|---|---|---|---|
| | ARCM:SR9035 | C16Br | C6Br | AA | SR9035 | ONE |
| Sample | (grams) | (grams) | (grams) | (grams) | (grams) | (grams) |
| EX 18, 19 | 10.0 | 0.65 | 0.0 | 0.65 | 0.0 | 0.08 |
| EX 20, 21 | 10.0 | 0.0 | 0.82 | 0.38 | 0.0 | 0.06 |
| EX 22, 23 | 0.0 | 4.0 | 0.0 | 4.0 | 6.0 | 0.04 |

TABLE 8
Test Results and Visual Observations

| | Coating | Adhesion | Rub | |
|---|---|---|---|---|
| | Surface | Test | Test | Visual |
| Example | Structure | Results | Results | Observation |
| EX18 | Flat | N/A | None removed | Clear |
| EX19 | Micro-replicated | 5 | None removed | Hazy |
| EX20 | Flat | N/A | None removed | Clear |
| EX21 | Micro-replicated | 5 | None removed | Hazy |
| EX22 | Flat | N/A | None removed | Clear |
| EX23 | Micro-replicated | 5 | None removed | Hazy |

### Example 24 (EX24)

Antimicrobial touch and efficacy testing was performed on the sample assembled as described in EX23. The control was the Melinex® PET flat film without a coating applied. Results are represented in Tables 9 and 10.

TABLE 9
Antimicrobial Touch Test Results

| | EX24 | | | Control | | |
|---|---|---|---|---|---|---|
| CFU Recovered | 13 | 85 | 102 | 545 | 600 | 465 |
| Log CFU Recovered | 1.11 | 1.93 | 2.01 | 2.74 | 2.78 | 2.67 |

| Average Log CFU Recovered | 1.68 | 2.73 |
|---|---|---|
| Average Log Reduction | 1.04 | n/a |
| % Reduction in Touch Transfer | 90.95 | n/a |

TABLE 10
Antimicrobial Efficacy Test Results

| | Time = | Standard | Time = | Standard | Log | % | |
|---|---|---|---|---|---|---|---|
| Example | 0 hours | Deviation | 24 hours | Deviation | Reduction | Reduction | Microorganism |
| EX24 | 6.62 | 0.09 | 0.59 | 1.02 | 6.03 | 99.9999 | P. aeruginosa |
| Control | 7.37 | 0.01 | 7.65 | 0.16 | −0.28 | N/A | P. aeruginosa |

### Example 25 (EX25)

Antimicrobial efficacy testing was performed on a sample prepared with the composition described in EX12. A multi-tipped diamond tool was used to create a micro-replicated surface, and the process described in Example 1 of US Pat Pub. No. 2013/0236697 (Walker et al) was used to create the film having a combination of microstructures and nanostructures on one surface with the opposite surface attached to a Melinex® PET. Sampling times of the test were modified (with samples incubated to 10 and 30 minutes) to determine variation over time. The control was the Melinex® PET flat film without a coating applied. Results are represented in Table 11.

### Example 26 (EX26)

Antimicrobial efficacy testing was performed on a sample prepared with the composition described in EX12. The coating was applied to a Melinex® PET flat film and cured with ultraviolet light. Sampling times of the test were modified (with samples incubated to 10 and 30 minutes) to determine variation over time. The control was the Melinex® PET flat film without a coating applied. Results are represented in Table 11.

TABLE 11
Antimicrobial Efficacy Test Results

| | | | Log | | Log |
|---|---|---|---|---|---|
| | Time = 0 | Time = 10 | Reduction | Time = 30 | Reduction |
| Example | minutes | minutes | - 10 min. | minutes | - 30 min. |
| EX25 | 7.73 | 1.97 | 5.70 | 0.39 | 7.32 |
| EX26 | 7.91 | 3.66 | 4.01 | 0.76 | 6.95 |
| Control | 7.80 | 7.67 | N/A | 7.71 | N/A |

The embodiments described above and illustrated in the figure are presented by way of example only and are not intended as a limitation upon the concepts and principles of the present disclosure. As such, it will be appreciated by one having ordinary skill in the art that various changes in form and detail are possible without departing from the present disclosure. Various features and aspects of the invention are set forth in the following claims.

1. A composition comprising:
an antimicrobial monomer represented by formula CH₂═C(R¹)—C(O)—O-Q-N⁺(R)₂CₙH₂ₙ₊₁(X—), wherein R¹ is hydrogen or methyl, Q is alkylene having up to six carbon atoms, each R is independently alkyl having up to four carbon atoms, n is an integer from 1 to 22, and X— is an anion;
a non-fluorinated crosslinking monomer having at least two acrylate groups, methacrylate groups, or a combination thereof, wherein the crosslinker is present in an amount of greater than 30 percent by weight, based on the total weight of the composition;
a polar monomer comprising at least one of acrylic acid, methacrylic acid, or a carboxylate salt thereof, wherein the polar monomer is present in an amount from 0 percent to 50 percent by weight, based on the total weight of the composition; and
a nonpolar monomer represented by formula CH₂═C(R¹)—C(O)—O—R² in an amount from 0 percent to 50 percent by weight, based on the total weight of the composition, wherein R¹ is hydrogen or methyl and R² is alkyl having from four to 18 carbon atoms;
wherein the antimicrobial monomer, the non-fluorinated crosslinking monomer, the polar monomer, and the nonpolar monomer together account for greater than 95 percent by weight, based on the total weight of the composition.

2. The composition of claim 1, wherein n is an integer from 12 to 16.

3. The composition of claim 1, wherein the non-fluorinated crosslinking monomer has at least three acrylate groups, methacrylate groups, or a combination thereof.

4. The composition of claim 1, wherein the non-fluorinated crosslinking monomer is present in an amount of at least 35 percent by weight, the polar monomer is present in an amount of at least 25 percent by weight, and the nonpolar monomer is present in an amount of 0 percent by weight.

5. An article comprising a film comprising a plurality of pendent groups represented by formula —C(O)—O-Q-N⁺(R)₂CₙH₂ₙ₊₁(X—) covalently bonded in a crosslinked acrylic network, wherein Q is alkylene having up to six carbon atoms, each R is independently alkyl having up to four carbon atoms, n is an integer from 1 to 22, and X— is an anion, and wherein the crosslinked acrylic network is derived from the composition of claim 1.

6. The article of claim 5, wherein the film has a surface comprising microstructures, nanostructures, or combinations thereof.

7. An article comprising a film having a surface comprising microstructures, nanostructures, or combinations thereof, the film comprising a plurality of pendent groups represented by formula —C(O)—O-Q-N⁺(R)₂ CₙH₂ₙ₊₁(X—) covalently bonded in a crosslinked non-fluorinated acrylic network, wherein Q is alkylene having up to six carbon atoms, each R is independently alkyl having up to four carbon atoms, n is an integer from 1 to 22, and X— is an anion.

8. The article of claim 7, wherein the crosslinked non-fluorinated acrylic network is derived from a composition comprising:
an antimicrobial monomer represented by formula CH₂═C(R¹)—C(O)—O-Q-N⁺(R)₂CₙH₂ₙ₊₁(X—), wherein R¹ is hydrogen or methyl, Q is alkylene having up to six carbon atoms, each R is independently alkyl having up to four carbon atoms, n is an integer from 1 to 22, and X— is an anion;
a non-fluorinated crosslinking monomer having at least two acrylate groups, methacrylate groups, or a combination thereof, wherein the crosslinker is present in an amount of greater than 25 percent by weight, based on the total weight of the composition;
a polar monomer comprising at least one of acrylic acid, methacrylic acid, or a carboxylate salt thereof, wherein the polar monomer is present in an amount from 0 percent to 50 percent by weight, based on the total weight of the composition; and
a nonpolar monomer represented by formula CH₂═C(R¹)—C(O)—O—R² in an amount from 0 percent to 50 percent by weight, based on the total weight of the composition, wherein R¹ is hydrogen or methyl and R² is alkyl having from four to 18 carbon atoms.

9. The article of claim 6, wherein the microstructures, nanostructures, or combinations thereof comprise at least one of continuous peaks and adjacent valleys, pyramids, cones, hemispherical bumps, upstanding posts, or cube corners.

10. The article of claim 6, wherein the microstructures, nanostructures, or combinations thereof have a complement cumulative slope magnitude distribution such that at least 30 percent have a slope magnitude of at least 0.7 degrees, and at least 25 percent have a slope magnitude of less than 1.3 degrees.

11. The article of claim 6, further comprising a substrate having a first structured surface, wherein the first structured surface comprises microstructures, nanostructures, or combinations thereof, wherein the film is disposed on the first structured surface.

12. The article of claim 11, wherein the substrate comprises a fluoropolymer.

13. The article of claim 11, wherein substrate has a second surface opposite the first structured surface, and wherein the article further comprises a pressure sensitive adhesive disposed on the second surface of the substrate.

14. The article of claim 6, wherein the article further comprises an interior or exterior surface of a vehicle, a housing or case of an electronic device, or a furniture component.

15. A process of making an article, the process comprising:
combining the composition of claim 1 with a photoinitiator,
coating the resulting composition onto a substrate; and
exposing the composition to actinic radiation to form a film.

16. The process of claim 15, wherein the substrate has a first structured surface, wherein the first structured surface comprises microstructures, nanostructures, or combinations thereof, and wherein the composition is coated on the first structured surface.

17. The process of claim 15, wherein the substrate comprises a tool having a negative replication of a surface comprising microstructures, nanostructures, or combinations thereof, the process further comprises removing the film from the tool.

18. The process of claim 15, further comprising thermoforming the article or the substrate.

19. The article of claim 8, wherein the polar monomer is present in an amount of at least 25 percent by weight based on the total weight of the composition, and wherein the nonpolar monomer is present in an amount of 0 percent by weight to 49 percent by weight, based on the total weight of the composition.

20. The article of claim 8, wherein the nanostructures are on the microstructures.
